(19) United States
(12) Patent Application Publication
(10) Pub. No.: US 2018/0302358 A1
(43) Pub. Date: Oct. 18, 2018

(54) METHODS AND SYSTEMS FOR PRESENTING UPDATES IN A MESSAGING THREAD

(71) Applicant: Facebook, Inc., Menlo Park, CA (US)

(72) Inventors: Akhil Nambiar, San Francisco, CA (US); Ming Xiao, Mountain View, CA (US); Weiwei Ding, Freemont, CA (US); Sarah Hum, San Francisco, CA (US); Tsung-Chuan Chen, Palo Alto, CA (US); Christopher Bing Chen, San Francisco, CA (US)

(21) Appl. No.: 15/486,790

(22) Filed: Apr. 13, 2017

(51) Int. Cl. H04L 12/58; H04L 29/08

(52) U.S. Cl. CPC H04L 51/08; H04L 67/26; H04L 51/14; H04L 51/04

(57) ABSTRACT

Exemplary embodiments relate to techniques for presenting and targeting media in communications services. Media, such as live events, updates on a topic of interest, or digests of news sites or other content providers may be surfaced to a user in a number of ways; for example, an article view relating to the topic, a messaging view showing message threads, a media view showing interesting pieces of media, or in an active conversation based on analysis of a conversation and trending topics, such as news events. A system may suggest recipients that may be interested in discussing the content. The recipients may be presented in a ranked order based, for example, on an affinity or relationship of the recipients to a publisher of the content. Publishers may add or remove topics, and may set an end-time at which updates cease. The updates may be presented in a messaging thread.

### BACKGROUND

Messaging systems, such as instant messaging systems and short message service (“SMS”) systems, allow users to communicate with each other by exchanging messages. Messaging systems may allow a sending user to transmit messages to one or more receiving users. In some cases, users may share media, such as news articles, through the messaging service.

### BRIEF DESCRIPTION OF THE DRAWINGS

FIG. 1A depicts an inbox interface for messaging application associated with a messaging service;

FIG. 1B depicts an alternative inbox interface including a set of media items;

FIG. 1C depicts an exemplary dedicated article view for presenting a set of media items;

FIG. 1D depicts an exemplary popup menu activated upon interaction with the sharing interface element in FIG. 1C.

FIG. 1E depicts an exemplary dedicated media view including an interface portion for conversing with users who have reacted to a media item;

FIG. 1F depicts an exemplary chat room view including an interface portion for conversing with users about an identified topic;

FIG. 1G depicts an exemplary participant recommendation interface for selecting users to participate in a conversation;

FIG. 1H depicts an exemplary conversation viewer interface including a message generated based on an analysis of messages in the conversation;

FIG. 1I depicts an exemplary opt-out message displayed in the conversation viewer interface;

FIG. 1J depicts an exemplary media digest message displayed in a conversation;

FIG. 1K depicts exemplary event update messages displayed in a conversation;

FIG. 1L depicts an exemplary topic subscription message displayed in a conversation;

FIG. 2 depicts an exemplary client/server architecture suitable for practicing exemplary embodiments;

FIG. 3A depicts an exemplary data flow diagram in which a user subscribes to receive a digest of media items;

FIG. 3B depicts an exemplary data flow diagram in which a user subscribes to receive updates about an event;

FIG. 3C depicts an exemplary data flow diagram in which a conversation is analyzed to identify topics of interest;

FIG. 4A is a flowchart depicting an exemplary technique for recommending groups and/or topics for which updates may be received;

FIG. 4B is a flowchart depicting an exemplary technique for analyzing a conversation to recommend topics for which updates may be received;

FIG. 5A is a block diagram providing an overview of a system including an exemplary centralized messaging service;

FIG. 5B is a block diagram providing an overview of a system including an exemplary distributed messaging service;

FIG. 5C depicts the social networking graph of FIGS. 5A-5B in more detail;

FIG. 6 is a block diagram depicting an example of a system for a messaging service;

FIG. 7 is a block diagram illustrating an exemplary computing device suitable for use with exemplary embodiments;

FIG. 8 depicts an exemplary communication architecture; and

FIG. 9 is a block diagram depicting an exemplary multicarrier communications device.

### DETAILED DESCRIPTION

In typical communications services (e.g., social networking services, messaging services, etc.), media consumption is a solo endeavor. For example, a user may retrieve and view media of interest, and only later will share the media with other users. Although a user may have an option to share the media and discuss the media through a conversation, one of the participating users must still typically locate media of interest, share the media, and initiate the conversation. As a result, some media of interest may be missed, and some conversations may not occur. Because administrators of a communications service typically desire to see increased use of the service, the conventional model in which individual users identify media of interest and share the media with others may not be optimal.

According to exemplary embodiments described herein, if a group of associated users of the communications service have interests in common (and the users authorize use of the embodiments), content may be identified automatically and delivered to the associated users as a group. For example, the users may be friends in a social networking service associated with a messaging service, or may be users who have included each other in their contacts list. This group updating may serve to spur conversations and may bring new media to the attention of the users.

According to some embodiments, topics of interest may be suggested and updates may be presented in an active conversation. Topic suggestions may be made based on an analysis of a conversation and recently trending topics, such as news events. According to further embodiments, which may be used separately or in conjunction with other embodiments, a system may suggest related participants that may be interested in discussing media content.

More specifically, media, such as live events, updates on a topic of interest, or digests of news sites or other content providers may be surfaced to a user in a number of ways; for example, an article view relating to the topic, a messaging view showing message threads, or a media view showing potentially interesting pieces of media.

Based on indicated interest in the media, potential participants in a conversation may be identified. For example, the media may be analyzed to identify topics related to the media, and other users interested in those topics may be suggested as possible participants in the conversation. A user may indicate interest in the media explicitly, such as by interacting with a conversation interface element, commenting on the media, reacting to the media (e.g., liking the media), sharing the media item, or through other express actions. In some embodiments, a user may also indicate interest in the media implicitly, such as by accessing the media item in a viewer, receiving a shared media item from a close friend, etc.

The participants may be presented in a ranked order based, for example, on an affinity or relationship of the recipients to a publisher of the content. The system may receive a selection of users identified to participate in the conversation.

For each user (assuming the user opts in or does not opt out), updates related to the original media and/or identified topics may be presented in a messaging thread, which may be a thread between a single user and a content provider, a single user and another single user, a group of users, or a single user and a room.

Updates may be presented in a digest form by accumulating multiple pieces of content over a predetermined time period and transmitting the accumulated media together. Alternatively or in addition, updates may be presented in real-time on a continual basis (e.g., as the updates are generated). The former approach may be well-suited to a situation where a user subscribes to receive updates on a topic of interest, whereas the latter approach may be well-suited to receiving updates on events that occur in real-time.

Updates may be received in the conversation thread until canceled, and may be received at predetermined time intervals. Alternatively or in addition, updates may run for a predetermined period of time. For example, a group of users may subscribe to receive news items related to the music industry; the system may accordingly deliver a news digest to the group once per day, once per week, etc. In another example, users may register to receive updates about an event; the updates may run until the event is concluded. In some embodiments, if updates run for a predetermined period of time and then expire (e.g., in the case of a live event), users in the message thread may be offered an option to subscribe to topics related to the updates after the period of time expires. Alternatively, the conversation thread may be automatically enrolled in updates about related topics, if authorized by the users.

Publishers of content items may periodically add or remove topics for consideration by the system. Publishers may also set an end-time at which updates cease.

This brief summary is intended to serve as a non-limiting introduction to the concepts discussed in more detail below. However, before discussing further exemplary embodiments, a brief note on data privacy is first provided. A more detailed description of privacy settings and authentication will be addressed in connection with the following Figures.

### A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for engaging in synchronous video conversation in a messaging system is next provided

As an aid to understanding, a series of examples will first be presented before detailed descriptions of the underlying implementations are described. It is noted that these examples are intended to be illustrative only and that the present invention is not limited to the embodiments shown.

### Exemplary Interfaces

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

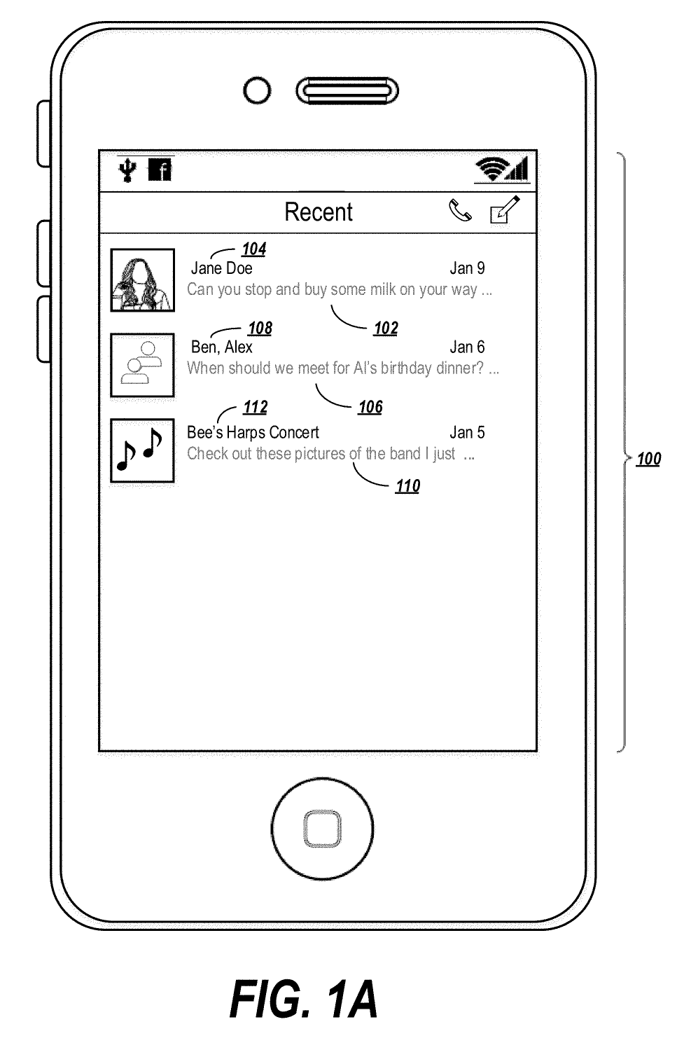

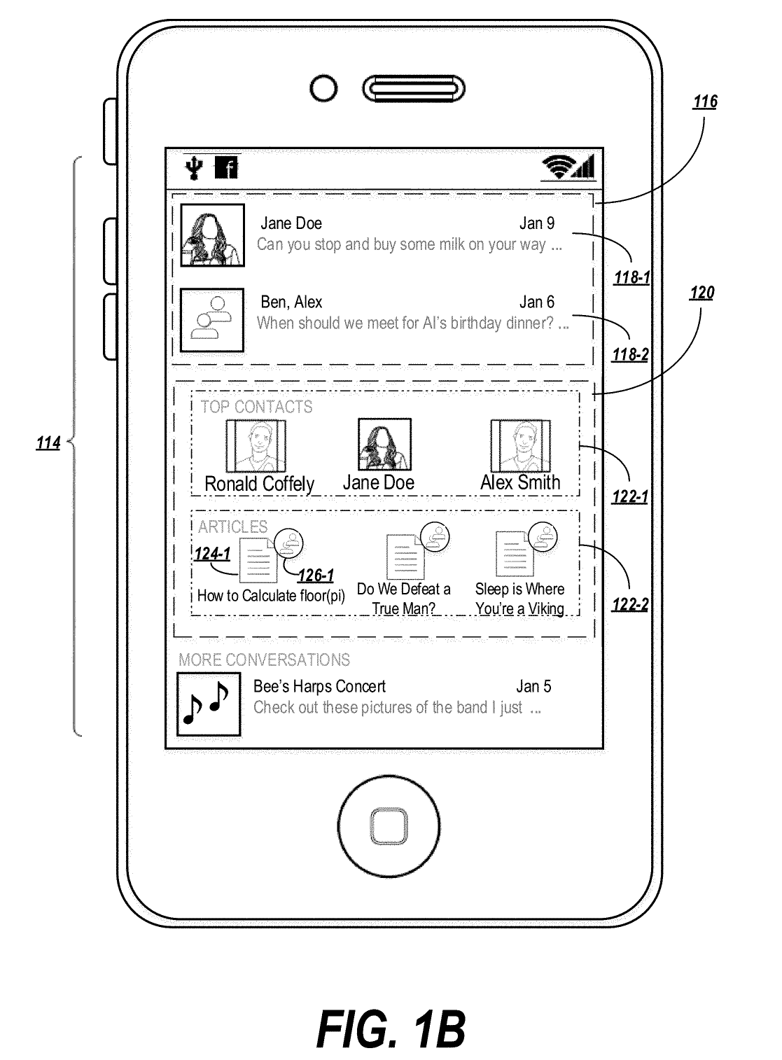

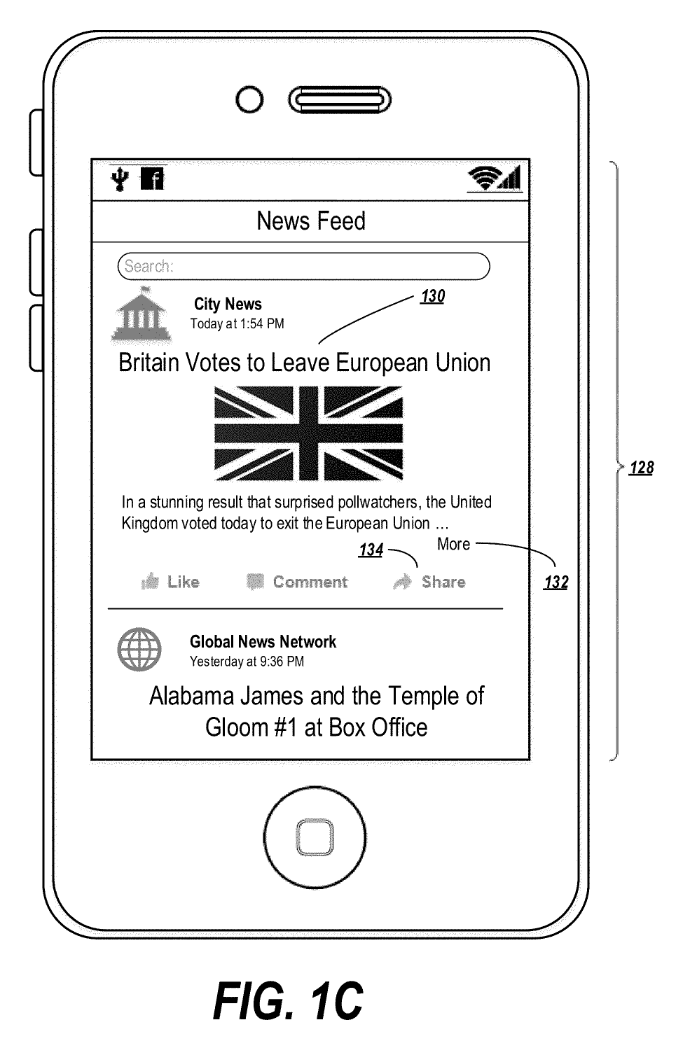

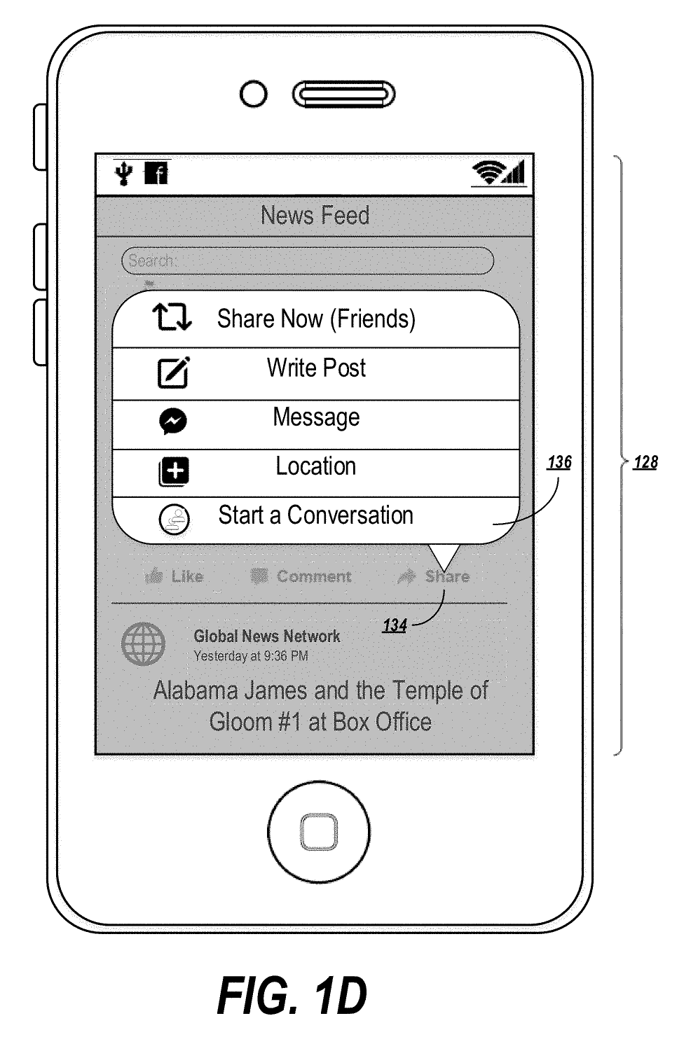

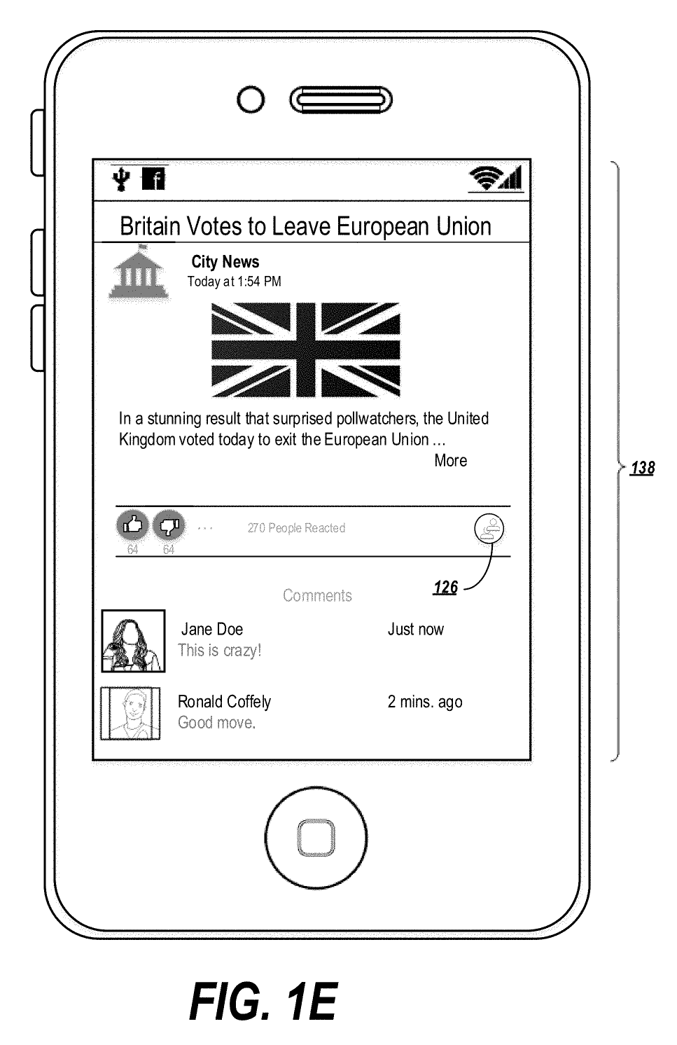

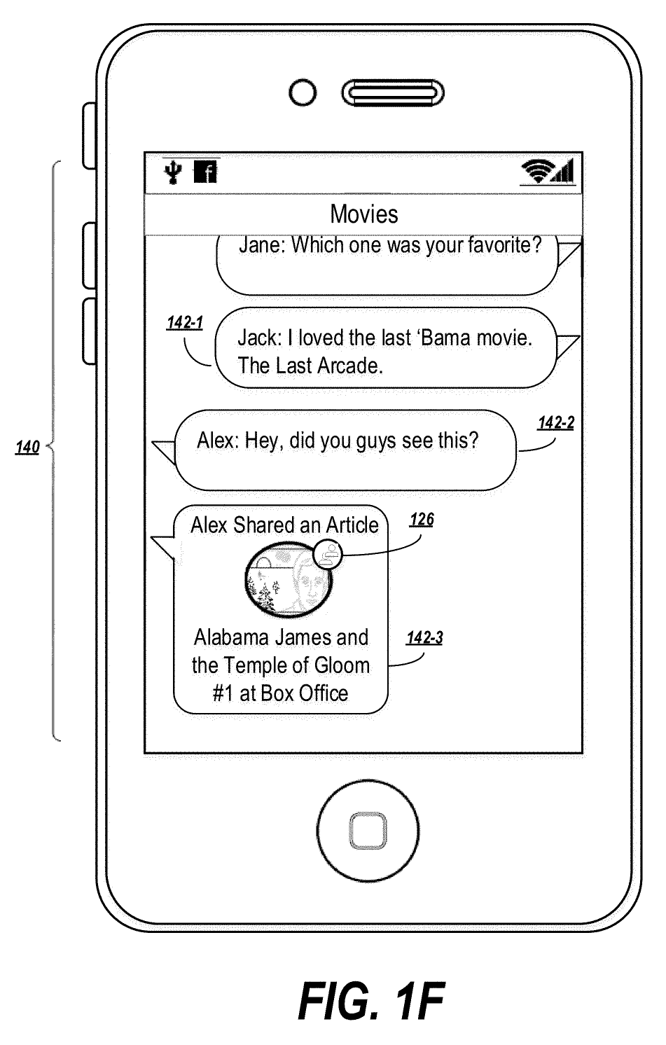

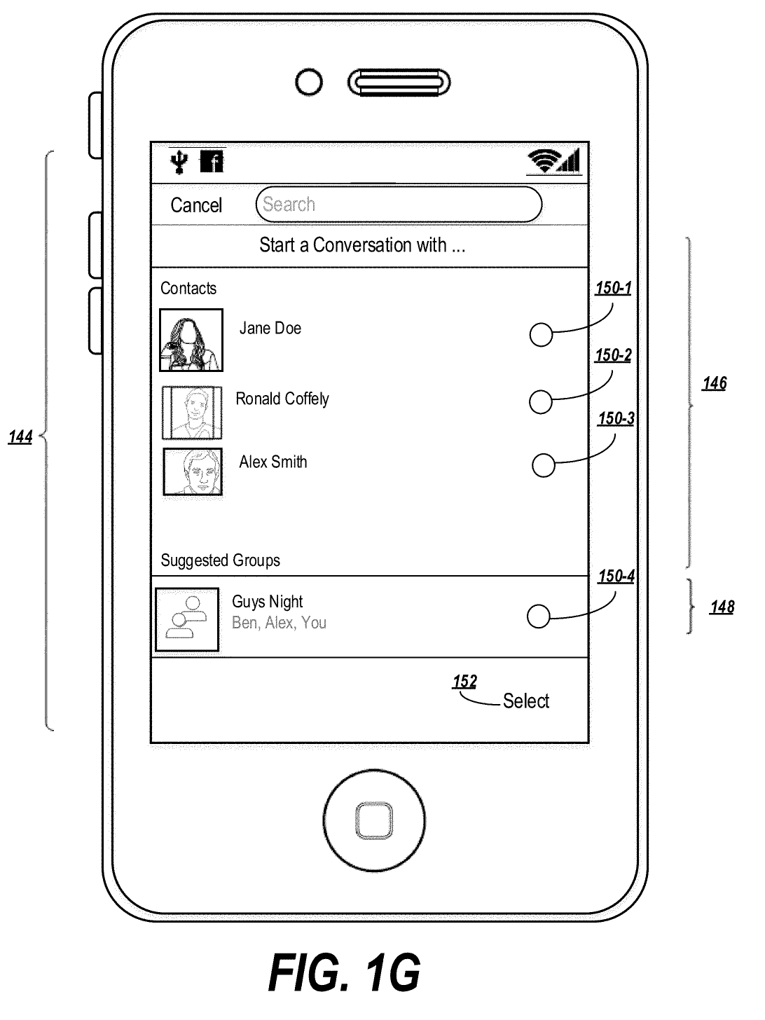

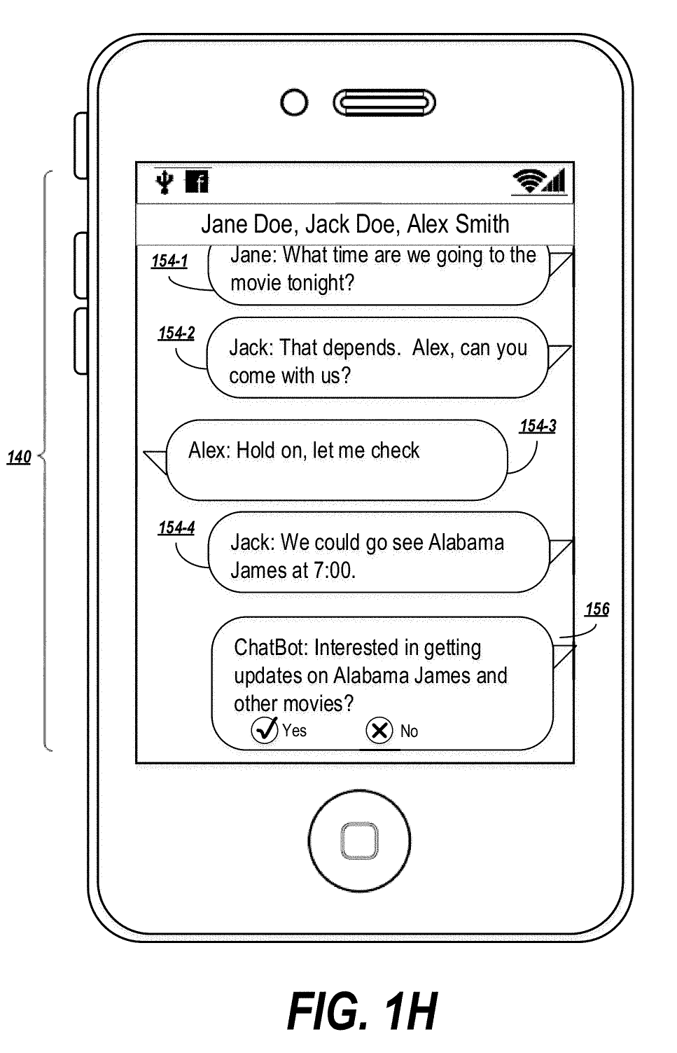

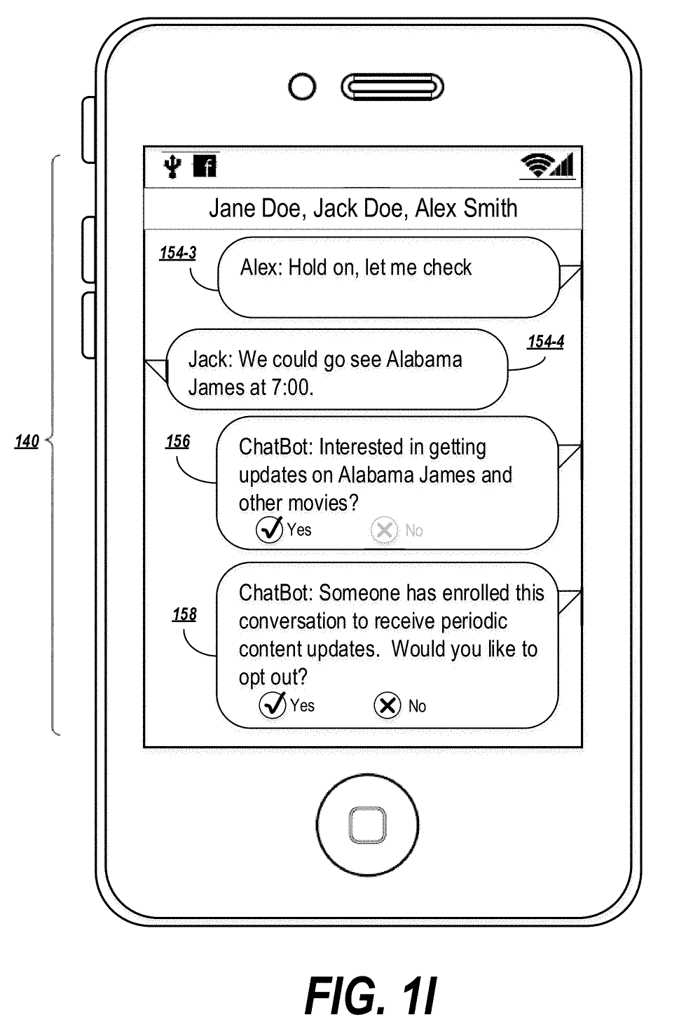

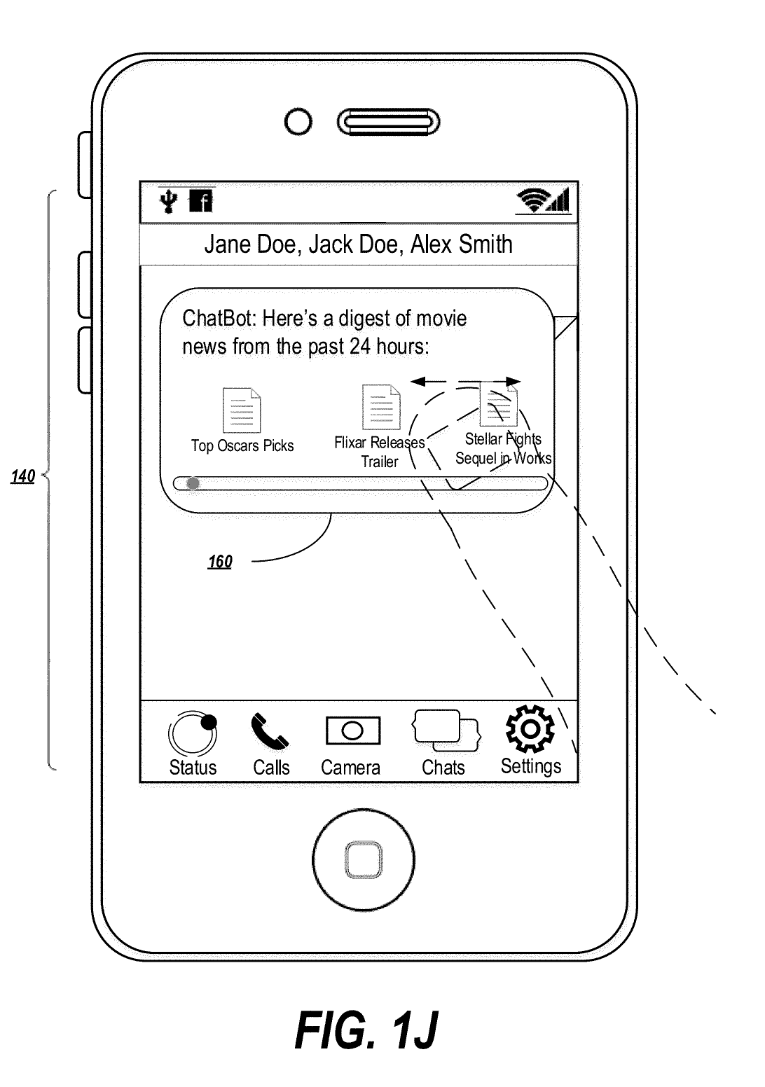

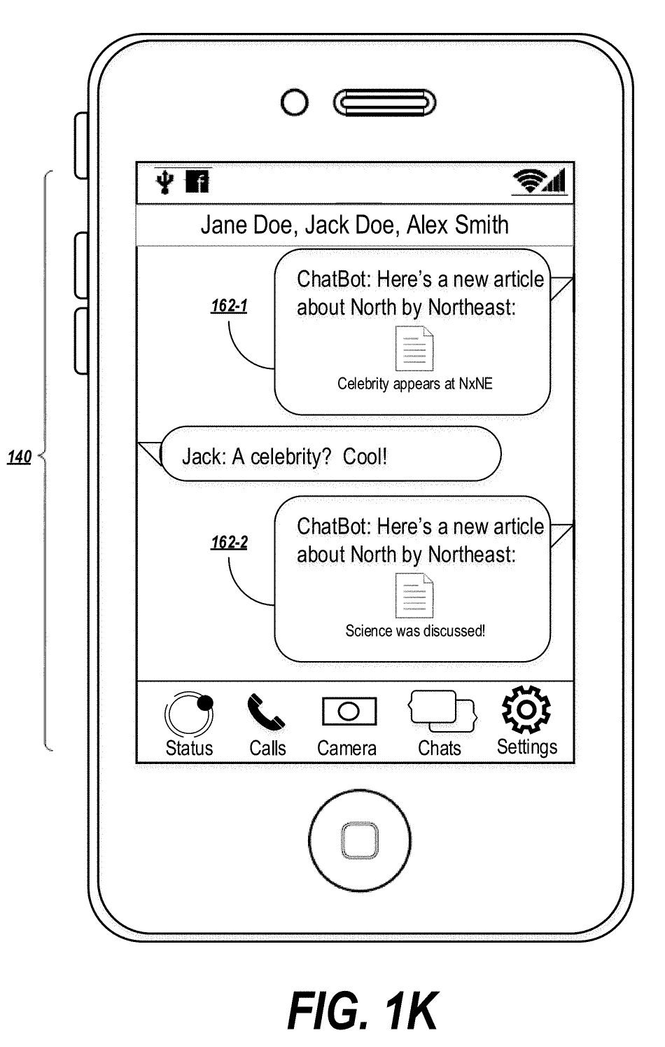

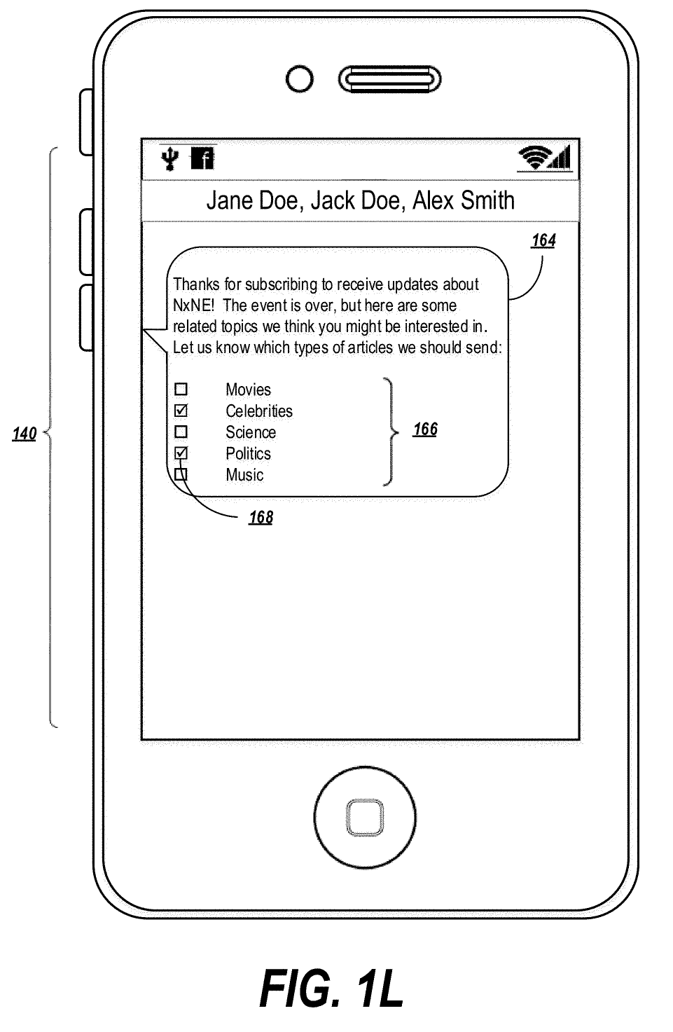

Users may interact with a messaging system through a client application. FIG. 1A depicts an example of a client application displaying a messaging interface 100. The messaging interface 100 of FIG. 1A shows an exemplary summary screen that provides an overview of messages recently sent to (or by) the user of the client application.

Messaging systems may support a variety of different types of messages. For example, the messaging interface 100 includes a summary of a one-to-one (or individual) message 102. A one-to-one message is a message exchanged between two entities, so that only the two entities can see and participate in the conversation. For example, in the one-to-one message 102, the current user (Jack Doe) recently received a message from his wife, Jane Doe. The other participant in the conversation is indicated in the interface 100 using an identifier 104 (including a name and profile picture, in this example). Only Jack and Jane participate in the conversation, and only Jack and Jane can view the conversation.

Another message type supported by the messaging system is a group conversation. In a group conversation, multiple users see and participate in the conversation. FIG. 1A depicts an exemplary summary of a group conversation 106. In the summary of the group conversation 106, each of the other users participating in the conversation is indicated by respective identifiers 108. In this case, the identifiers include the names or handles of the other users participating in the group conversation, and an icon to indicate that the conversation is a group conversation. For example, in this case the current user (Jack) is participating in a conversation with his friends Ben and Alex. Jack, Ben, and Alex can each see all of the messages in the conversation (regardless of who sent the message) and can send messages to the group.

Another type of message supported by the messaging system is a message between one or more users and an organization (such as a business) or event. For example, FIG. 1A shows an event message 110 sent by the current user (Jack) to the page of an event being organized through a social network. The identifier 112 identifies the name of the event, and an icon is presented identifying this particular event is a concert. In an event message 110, all participants in the event (as a participant is defined, e.g., by the event's social networking page) can view and send event messages 110. Participants may include, for example, people attending the event, fans of the event that have signed up with the event's page to receive messages about the event, event organizers, etc.

The interface 100 includes interface elements allowing the user to create a new message or conversation. Moreover, by selecting an existing message summary 102, 106, 110, the user can view messages in an existing conversation and add new messages to the conversation.

FIG. 1B depicts an alternative exemplary interface 114 for a messaging inbox. The interface includes a first portion 116 for displaying a first set of messages 118, a second portion 120 displaying one or more modules 122, and (optionally) a third portion displaying further messages. Although FIG. 1B depicts each of the first portion 116, the second portion 120, and the third portion together on a single screen of the device, any or all of the interface portions may extend to or beyond a single device screen. The user may navigate through the interface 114, for example by scrolling.

According to exemplary embodiments, one or more of the modules 122 may relate to media items or other content. For example, in the depicted interface 114, the module 122-2 includes a list of articles 124-i available to the user. The user may interact with an articles 124-i to enter a full-screen or enlarged view of the article. The articles 124-i presented in the module 122-2 may include articles that are predicted to be of interest to a user associated with the interface 114.

Each of the articles 124-i may be associated with a conversation interface element 126-i. Interaction with the conversation interface element 126-i may be taken by the system as an explicit indication of interest in the corresponding media item 124-i that triggers the system to identify potential participants in a conversation about the media item 124-i and/or topics related to the media item 124-i. Interaction with the article 124-i (e.g., in order to view the article) may, in some embodiments, be treated as an implicit indication of interest in the media item 124-i.

Users may also indicate interest in a media item via an article view 128, as depicted in FIG. 1C. The article view 128 may present multiple media items that a system determines are likely to be of interest to a user. An article view 128 may present media items on multiple different topics of interest to a user, or may be focused on a particular topic or publisher. For example, an article view 128 may be a news feed from a social networking service, a digital magazine displaying multiple articles, etc.

The article view 128 may display a headline phrase or sentence 130 providing a brief overview of the media item. Depending on the configuration and user preferences, relatively short media items may be displayed in the article view 128 in their entirely. Alternatively, a summary or limited preview of the media item may be displayed in the article view 128, along with an expansion interface element 132 allowing a larger version of the media item to be displayed.

Each media item may be associated with a sharing interface element 134 that, upon selection, may present a pop-up menu, as shown in FIG. 1E. The menu may offer different techniques for sharing the media item with other users. For example, the menu may include a selectable conversation option 136 that instructs the system to identify a group of participants associated with the current user likely to be interested in conversing about the media item and/or related topics. Selection of the conversation option 136 may be taken by the system as an explicit indication of interest in the media item. Users may also be capable of implicitly indicating interest in the media item through the menu (or through other interface elements of the article view 128, such as by sharing the media item with friends, writing a post about the media item, reacting to the media item, commenting on the media item, etc.

Users may also indicate interest in a media item via a media view 138, as depicted in FIG. 1D. A media view 138 may relate to a particular media item and may provide an interface whereby multiple users can communicate about the media item. For example, the media view 138 may display a conversation between people who have reacted to a media item, may display a comments section for commenting on a media item, etc.

The media view 138 may include a conversation interface element 126 for instructing a system to identify a group of participants associated with the current user who may be interested in conversing about the media item. Selection of the conversation interface element 126 may be taken by the system as an explicit indication of interest in the media item. Users may also implicitly express interest in the media item in the media view 138, such as by commenting on the media item, reacting to the media item, reacting to a comment on the media item, etc.

Users may also indicate interest in a media item via a chat room view 140, as depicted in FIG. 1F. A chat room view 140 may relate to a topic and may provide an interface whereby multiple users can communicate about the topic via messages 142-i. For example, the chat room view 140 may display a conversation between people who share an interest in a topic to which a media item relates.

In the chat room view 140, a user may be enabled to share a media item (e.g., in a message 142-3). The media item may be associated with a conversation interface element 126 for instructing a system to identify a group of participants associated with the current user who may be interested in conversing about the media item. Selection of the conversation interface element 126 may be taken by the system as an explicit indication of interest in the media item. Users may also implicitly express interest in the media item in the chat room view 140, such as by interacting with the media item to view an enlarged version of the media item, referencing the media item in a message 142-i, etc.

Upon express interest in a particular media item, the system may identify a set of recommended users who are likely to have an interest in the media item or a topic related to the media item. As shown in FIG. 1G, the system may present the list of recommended users to the user who originally expressed the interest to allow the original user to select users with whom they would like to start a conversation. The list of users may be displayed in a user selection interface 144.

The users selected may be drawn from a contacts list or a friends list of the original user. For example, if the original user's messaging account is associated with a related account on a social networking service, the original user's friends list on the social networking service may be accessed to determine a list of candidate users for inclusion in the user selection interface 144. Alternatively or in addition, the user's contacts in the messaging service, which may include the contacts in the original user's contacts list (e.g., accessed on the original user's mobile device) may be accessed to identify candidate recipients.

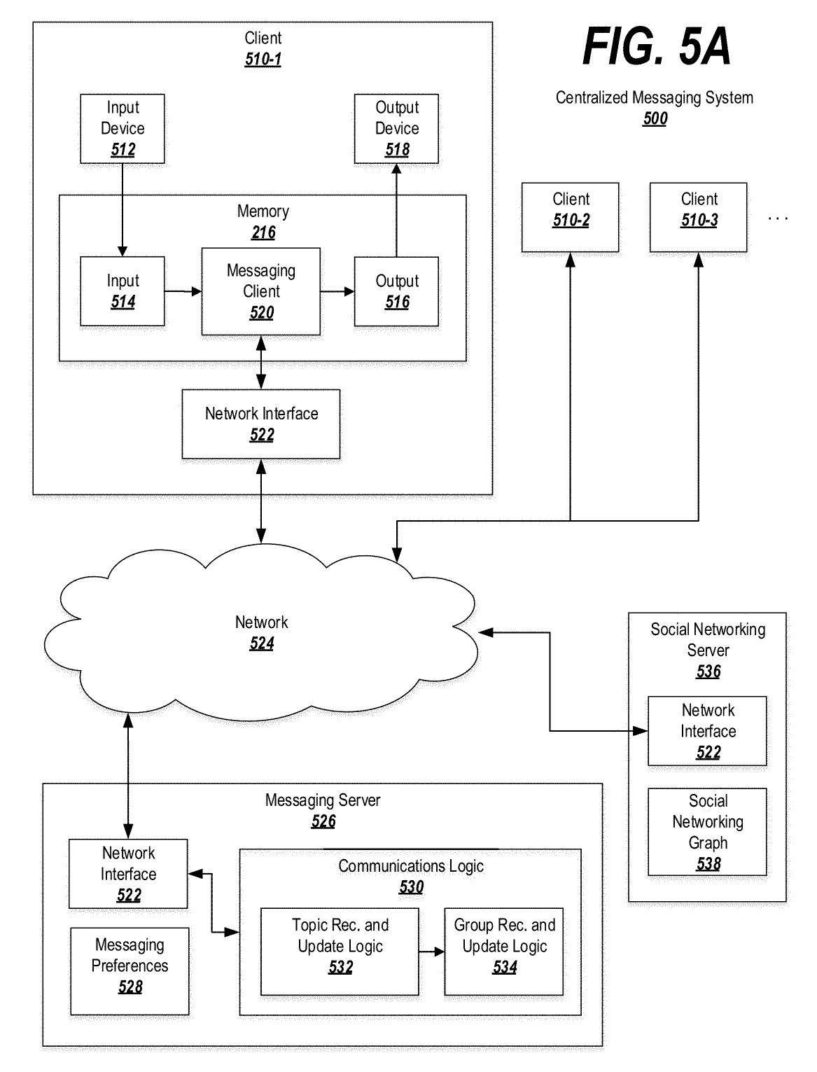

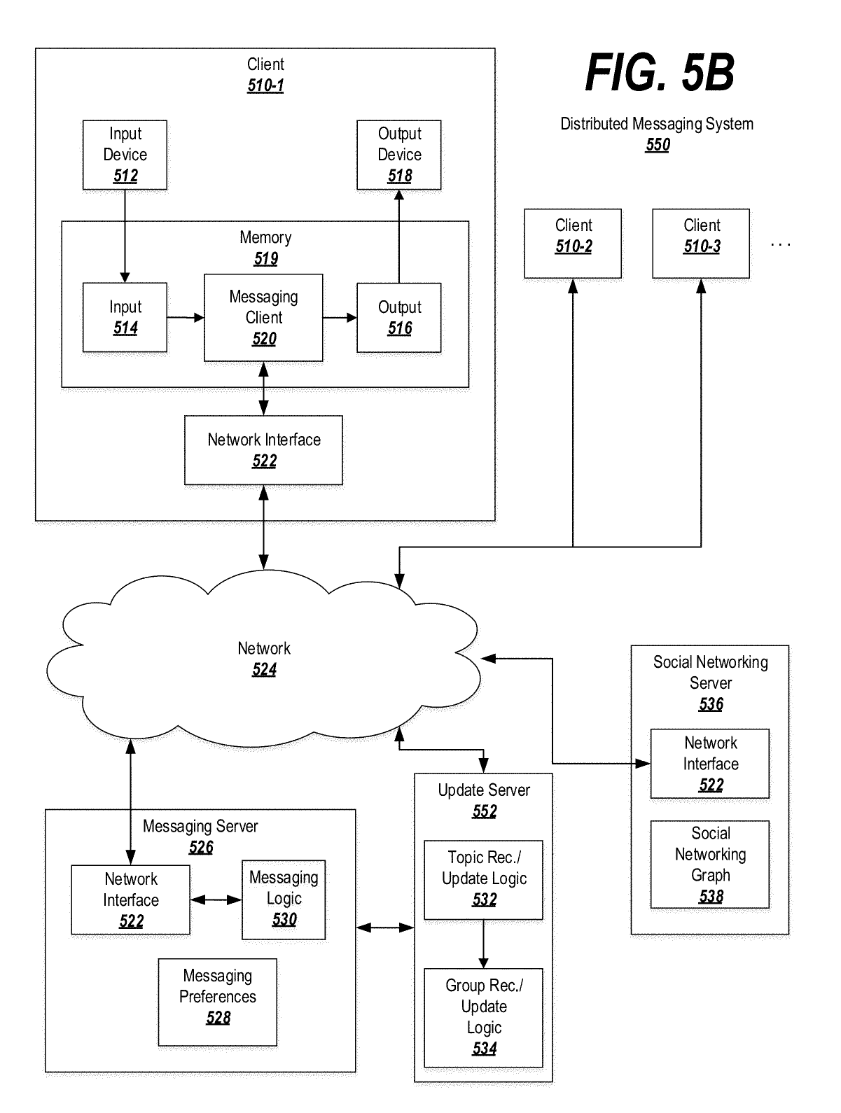

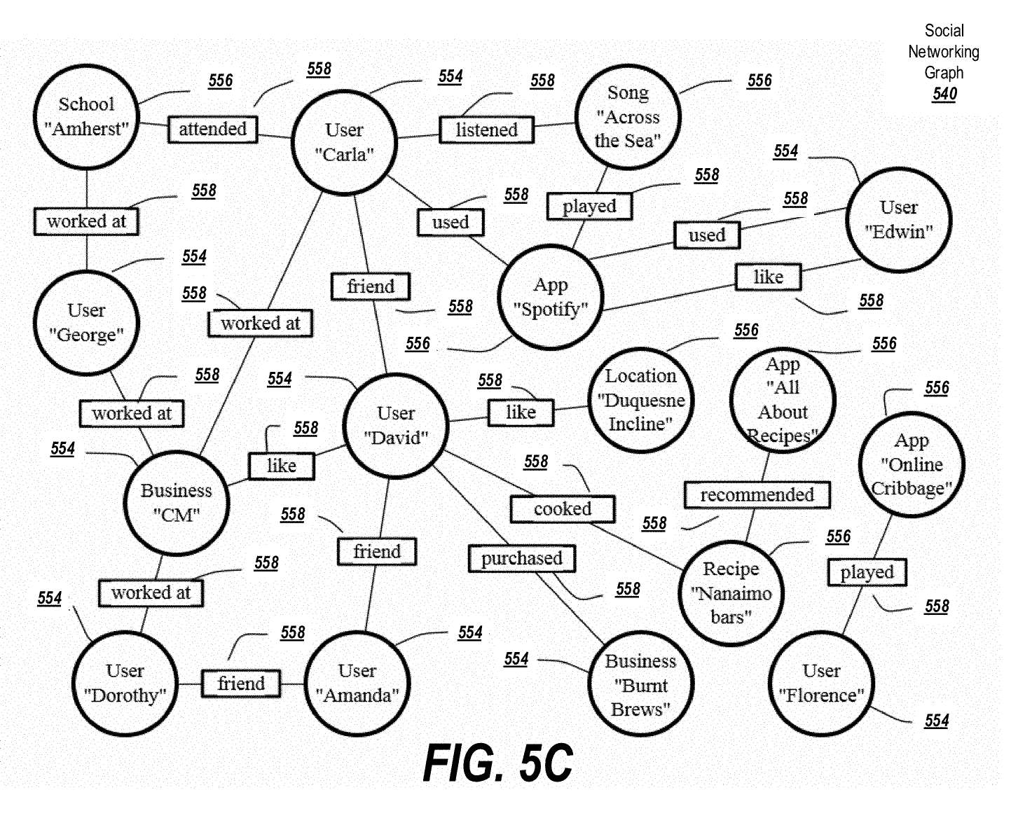

Once identified, a list of candidate recipients may be filtered and/or ranked. For example, the list of candidates may be ranked based on an affinity of each user for the publisher of the media (as determined, e.g., based on a strength of a connection between the user and the publisher in a social graph, see FIG. 5C). The list may be filtered based on similar criteria (e.g., if any of the users have blocked the publisher, the user may be filtered from consideration).

Alternatively or in addition, the candidate list may be ranked based on the likelihood that the candidate user will be interested in the originally shared media that prompted the conversation, and/or one or more topics associated with the media. The topics may be identified by a publisher of the media, and/or may be determined based on an analysis or meta-analysis of the media. For example, textual, image, and/or audio analysis may be performed on the media to identify topics associated with the media. Meta-information associated with the media, such as comments on the media, interests of users who have reacted to the media, etc. may also be consulted to identify topics associated with the media.

The user selection interface 144 may include a first portion 146 including a list of candidate recipients in the ranked order. Optionally, the user selection interface 144 may include a second portion 148 allowing a group associated with the original user to be selected. Groups may be evaluated, for example, based on the rankings of the individual users in the group (e.g., based on an average interest score of the group members, etc.). Such an embodiment may be useful in the situation where the user has already participated in a conversation with a group of people that was focused on a particular topic.

Each user and/or group may be associated with a selectable element 150-i in the user selection interface 144. By selecting the selectable elements 150-i, the original user may define a group of recipients to participate in a conversation relating to the original media. More than one selectable element 150-i may be selected to define the group. Once the user is satisfied that the group has been defined, the user may select a group finalize element 152 to instruct the system to use the selected users and/or groups as the basis for the conversation.

As an alternative to the user selection interface 144, the system may automatically select a group of the n highest ranked users, where n is a predetermined and/or user-configurable integer.

The above-described embodiments relate to a system in which a user expresses interest in a media item or topic and is presented with a group of suggested users to participate in a conversation. Alternatively or in addition, the user may be participating in a conversation with a pre-existing group, and the system may recommend that the user receive updates on a particular topic based on an analysis of the conversation. The system may be required to receive authorization from each member of the conversation before analyzing the conversation.

Assuming that the participants consent, the conversation may be analyzed to identify or tag topics of the conversation. Examples of techniques for identifying topics from the conversation are described, for example, in U.S. patent application Ser. No. 13/167,701, filed on Jun. 24, 2011 and entitled “Inferring Topics from Social Networking System Communications.”

After a topic has been identified, the system may transmit a message to the pre-existing group to suggest that the group receive updates on the topic, as shown for example in FIG. 1H. FIG. 1H depicts an example of a conversation viewer interface 140 in which users have exchanged a series of messages 154-i. Recent messages may be analyzed to identify the topics of the conversation. The system may also consult trending news stories (e.g., on a social network or third-party news or media site) and may correlate the trending news stories with the topics identified in the conversation. Furthermore, the participants' profiles and preferences may be consulted, if available, to identify interests, likes, dislikes, etc. of the users.

Based on this information, the system may determine whether to recommend updates on a topic of conversation. In order to prevent spamming the users, not all topics on conversation will necessarily result in a recommendation. In some cases, the system may require either or both of a high likelihood that the users are focused on a particular topic (as determined by analyzing the conversation) or cross-correlation with trending news stories (which would indicate both a likelihood that the users are discussing a currently relevant topic and hence may be interested in receiving updates, and that content is available to provide the updates).

Once the system has determined that the participants should be presented with an option to receive updates, the system may cause a message 156 to be transmitted into the conversation offering the opportunity to receive updates. The message 156 may include text content explaining the updates that are being offered (e.g., identifying the topics to be covered by the updates) and interactable elements allowing the users to consent to the updates or to cancel the updates.

In some cases, only a subset of the users may be interested in receiving the updates. Accordingly once at least one user consents to receiving the updates, the remaining users may be presented with an opportunity to opt-in or opt-out of receiving the updates. For example, FIG. 1I depicts an example of an opt-out message 158 including explanatory text and interactable elements transmitted into the conversation. Interacting with the opt-out message 158 may cause the interacting users not to receive updates. Alternatively or in addition, the user may be presented with an opt-in message, which would cause the user to opt in to receiving updates. Opt-out and/or opt-in preferences may be set by each user in a settings interface.

If all users in the conversation elect to receive the updates, then the updates may be transmitted to the conversation participants as a group (e.g., in the context of the conversation). If some participants opt out or do not opt in to receiving the updates, then a new conversation may be created (e.g., associated with a new thread identifier) including only those participants who have consented to receiving updates.

The updates may be in the form of a digest of media items that includes a number of media items received from the publisher of the original media item and/or other media items related to the same topic(s) as the original media item. A digest of media items may be transmitted at predetermined intervals, or on a selected schedule. Alternatively or in addition, a predetermined number of media items may be aggregated and transmitted when the digest includes the predetermined number.

In some embodiments, the digest of media items may be transmitted to the group of conversation participants in a digest message 160, as depicted in FIG. 1J. The digest message 160 may be addressed to a thread ID associated with the participants and/or conversation.

The media items contained in the digest message 160 may be represented by interactable elements. If it would be difficult or impossible to fit the digest message media items into the space afforded to a single message 160 on the display, then the media items may be accessed by scrolling in the display, as shown in FIG. 1J. Alternatively or in addition, the media items may be split between multiple messages 160.

In some cases, the original media item which sparked the conversation may relate to an event, (e.g., a live event occurring on a social network or another type of event). In such cases, media items may be transmitted into the conversation as they are generated (e.g., on a real-time basis). An example of messages 162-i including updates relating to an event are depicted in FIG. 1K.

In the case of an article digest as shown in FIG. 1J, digest messages may continue to be sent at a predetermined rate or on a predetermined schedule until canceled by the user(s) participating in the conversation. In the case of event updates as shown in FIG. 1K, media items may be transmitted for a predetermined period of time or until predetermined conditions are met (e.g., 1 day, or until the event ends). In either case, when the updates are canceled or expire, a user may be presented with an opportunity to subscribe to receive updates on related topics, as shown in FIG. 1L.

In some embodiments, the opportunity may be in the form of a topic subscription message 164 transmitted to the group participating in the conversation for which updates have just (or are about to) expire. The message 164 may include a list of topics 166 related to the original media item and/or topics that have been discussed in the conversation. The list of topics 166 may be ranked based on their relevance to the original media item and/or the conversation, and/or a predicted likelihood that the participants in the conversation will be interested in the topics. Each topic in the list 166 may be associated with an interactable element 168 allowing the receiving user to select a topic.

Upon selecting one or more interactable elements 168, the system may subscribe the conversation to receive updates on the topics in a manner similar to that discussed above in connection with FIGS. 1H-1I. If some participants elect to receive updates on a particular topic but others do not, then the topics for which some participants have not elected to receive updates may be split into a new conversation including only the electing participants. Optionally, the user or users subscribing to receive the updates may be presented with a new list of contacts (as shown, e.g., in FIG. 1G) to add new users to the conversation.

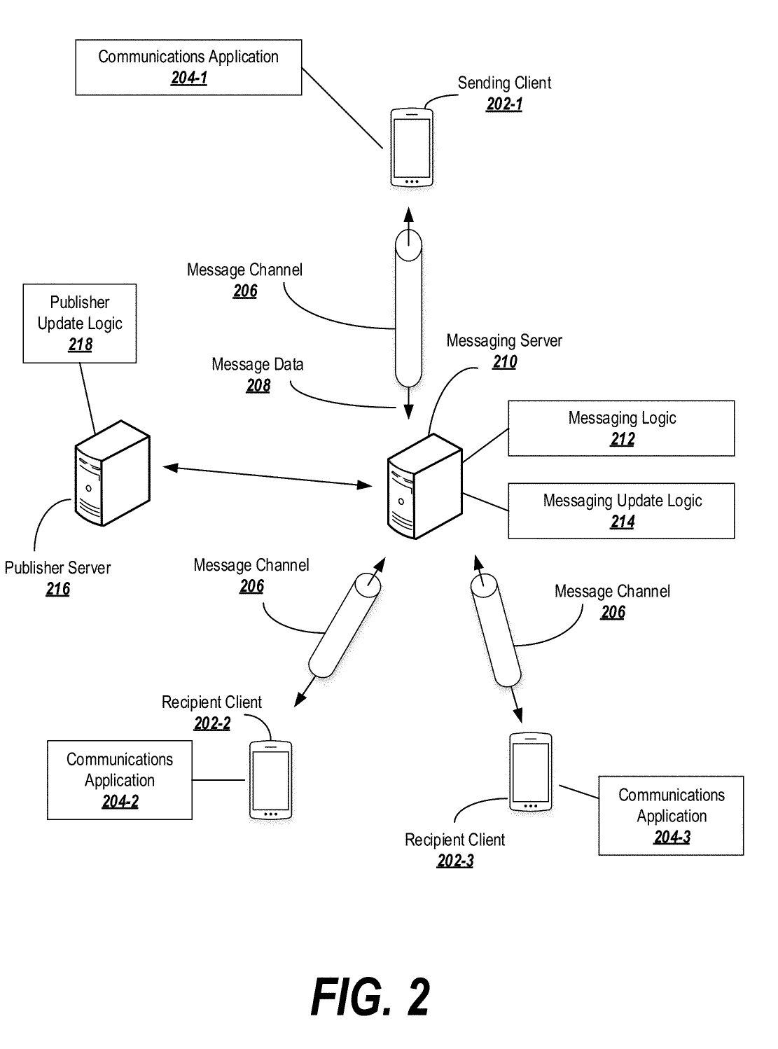

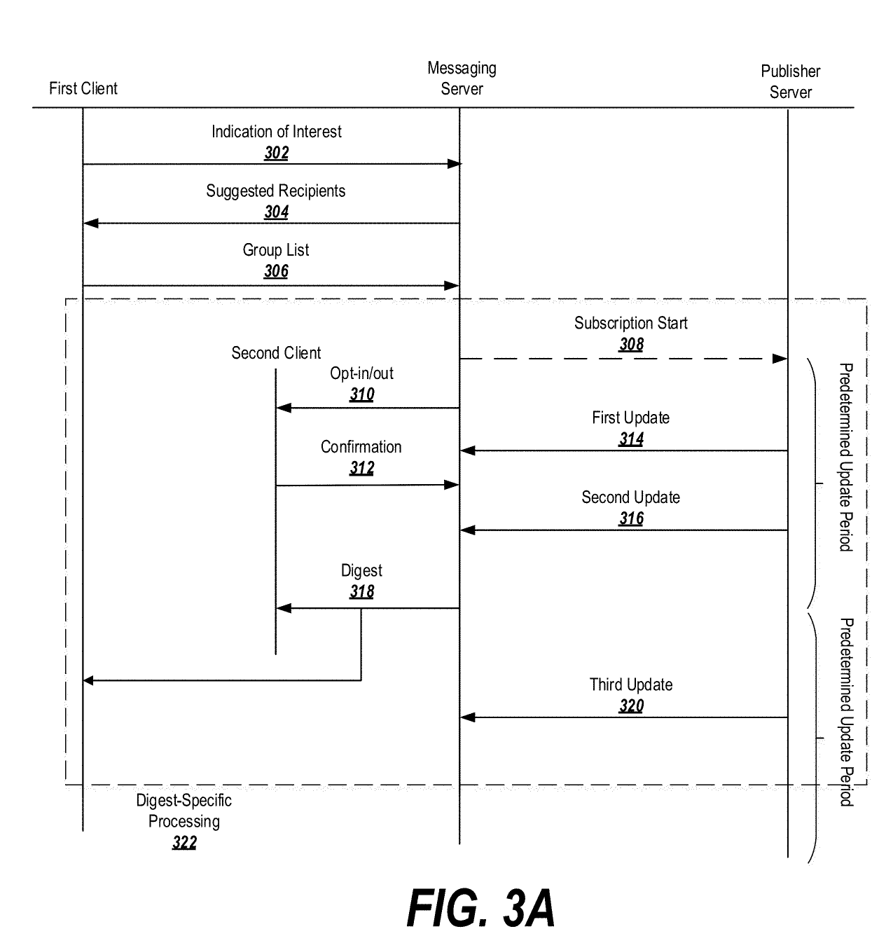

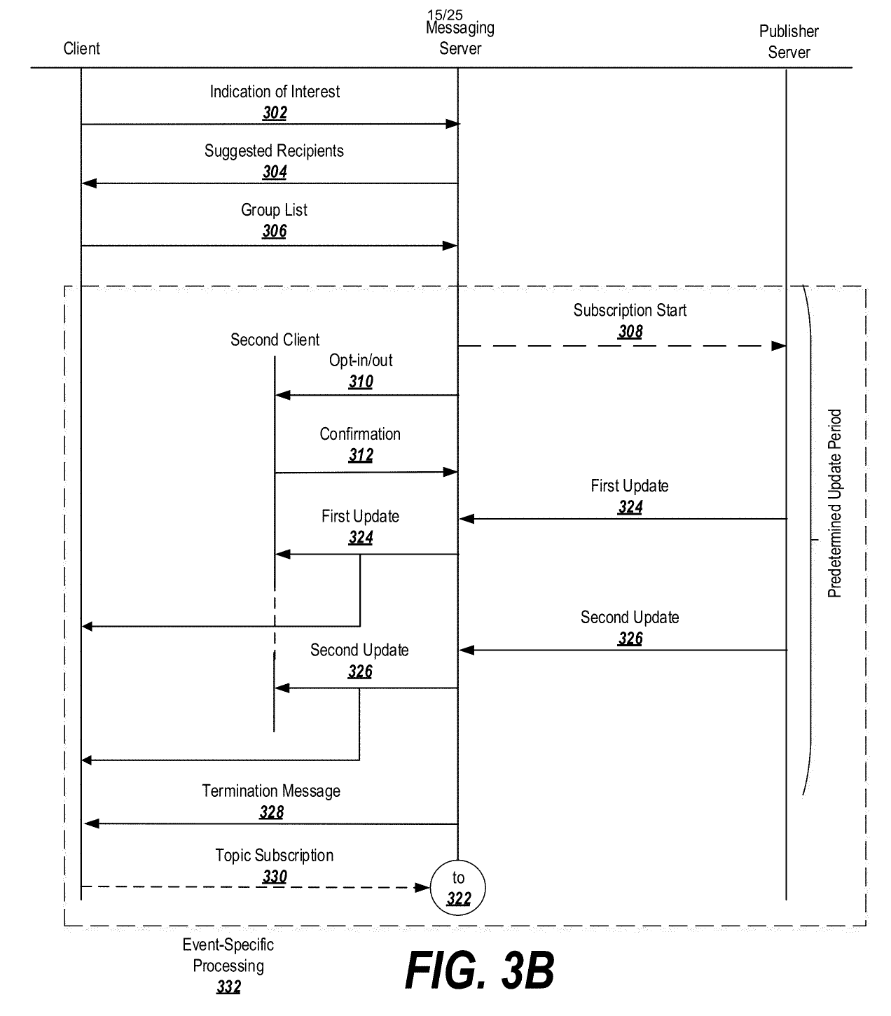

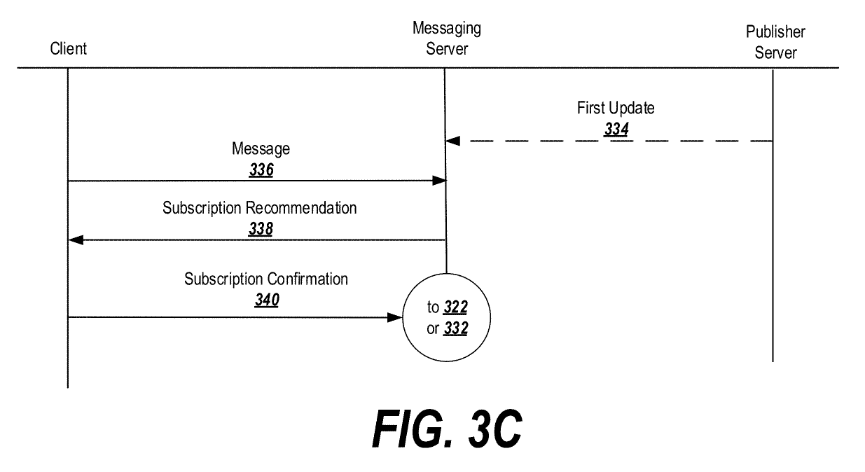

Next, an exemplary client/server system for supporting messaging drawing, and exemplary exchanges of information between the clients and servers are described with reference to FIGS. 2-3C.

### Exemplary Client/Server System and Information Exchange

FIG. 2 depicts an exemplary system including clients 202-i and at least one server 210 for processing messaging updates.

The clients 202-i may be mobile devices, such as phones, tablets, etc., and may be equipped with touch-sensitive displays capable of registering haptic feedback. The clients 202-i may be provided with respective communications applications 204-i, such as applications that allow the clients 202-i to access the capabilities of a messaging service or other type of communications service (e.g., a live video broadcasting service, a video calling service, etc.).

The clients 202-i may communicate with the server 210 through one or more channels. For example, a message channel 206 may carry message data pertaining to synchronous or asynchronous information transmitted from the communications application. The messages may be, for example, messages in a messaging service associated with a conversation through a thread ID.

A messaging server 210 may receive the message data 208, process the data, and forward it to appropriate recipients. For example, the messaging server 218 may retrieve a thread ID from a message 208 determine a set of participants associated with the thread ID, and forward the data to the client devices 202-i of the participants. To this end, the messaging server 210 may include messaging logic 212 for processing message data 208. At the receiving client side, each recipient client 202-i may include a communications application 204-i configured to process messages and drawing data and to display the messages on a communications viewer interface.

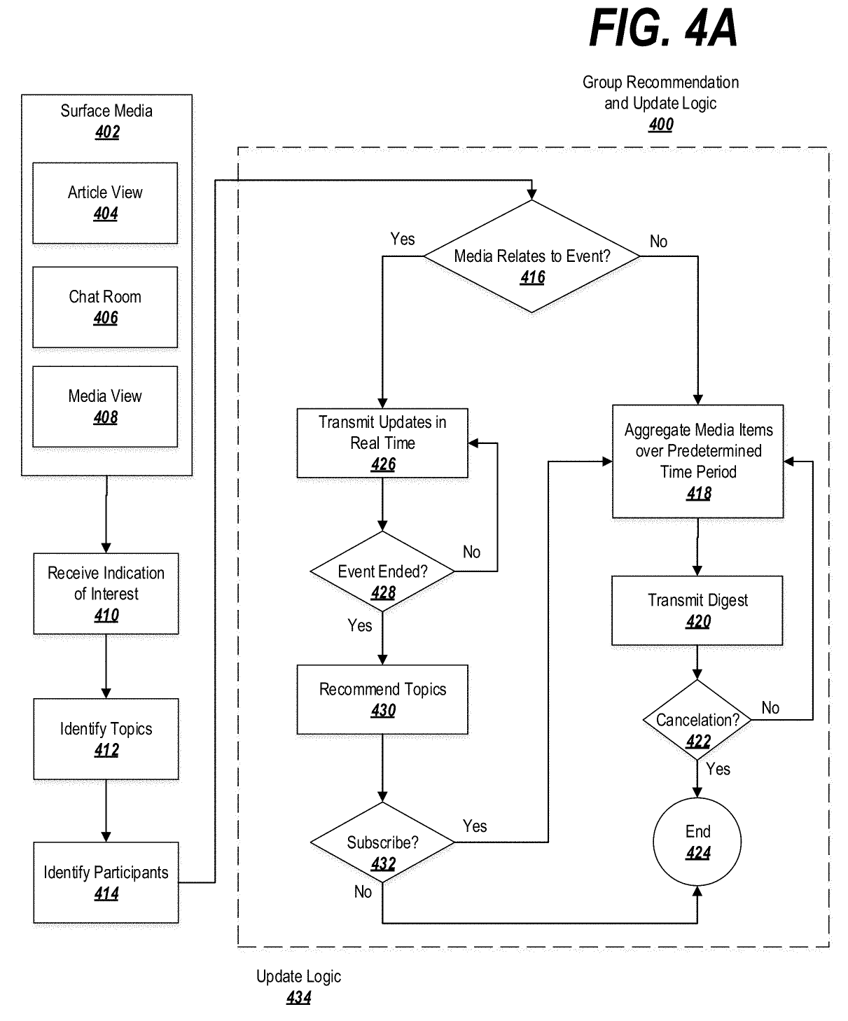

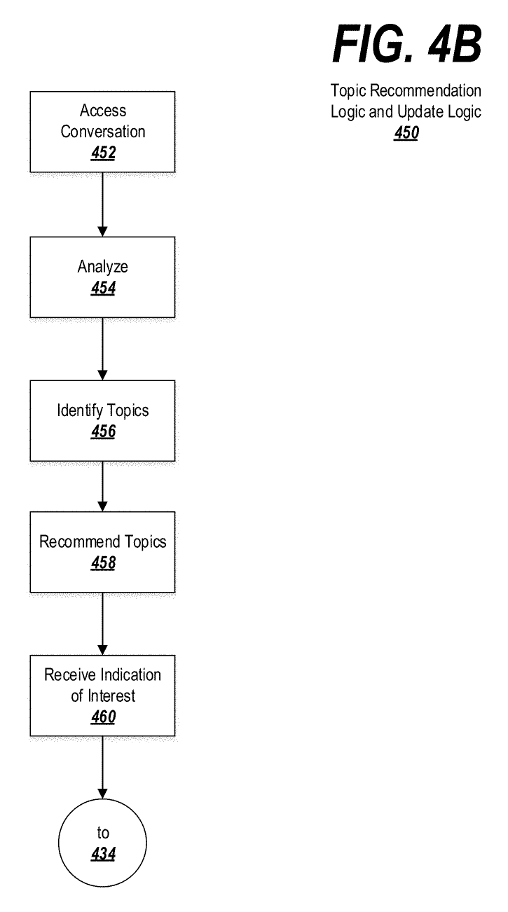

The messaging server 210 may process message data and/or social networking data in order to recommend groups and/or topics for conversations. Accordingly, the messaging server 210 may include messaging update logic 214 for recommending groups and topics. For example, the messaging update logic 214 may include some or all of the logic described below in connection with FIGS. 4A-4C.

To receive updates on media items, topics, events, etc., the messaging server 210 may communicate with one or more publisher servers 216. The publisher servers 216 may transmit media items to the messaging server 210 on a real-time basis (e.g., as each media item is generated) and/or in a digest form, at predetermined intervals or on a predetermined schedule. To this end, the publisher server 216 may include publisher update logic 218 configured to provide media items to the messaging service and/or an associated social networking service. Alternatively or in addition, the publisher update logic 218 may make media items available for retrieval by the messaging server 210. For example, the messaging update logic 214 may include logic to query the publisher update logic 218 as to whether new content is available (e.g., at predetermined intervals or on a designated schedule) and, if so, to request the media items from the publisher update logic 218.

Alternatively, as described in more detail in connection with FIG. 5B below, a separate update server may be provided in communication with the message server 210. The update server may provide capabilities for processing messaging updates on behalf of the messaging service, and may thus include the messaging update logic 214.

FIG. 3A is a flow diagram depicting an exemplary exchange of information in a communications system, such as the client/server system depicted in FIG. 2.

A first client may present a media item and receive an indication of interest in the media item. The first client may transmit a message 302 identifying the indication of interest to the messaging server.

In response to receiving the indication of interest, the messaging server may identify one or more suggested recipients to participate in a conversation about the media item. A list 304 of the suggested recipients may be forwarded to the first client, and the first client may display a user selection interface based on the list of suggested recipients 304. A user of the first client may select some or all of the suggested recipients and/or may select additional recipients not present in the list of suggested recipients.

When the user is satisfied with their selections, the first client may transmit a group list 306 back to the messaging server. The group list 306 may identify the users to participate in a conversation about the media and/or topics identified.

Upon receiving the group list 306, the messaging server may optionally transmit an indication 308 to the publishing server. The indication 308 may indicate that at least one user has subscribed to receive updates including content providable by the publisher server. In response to receiving the indication 308, the publisher server may begin transmitting updates to the messaging server.

Alternatively or in addition, the subscription may be managed by the messaging server without necessarily informing the publisher server. The publisher server may, regardless of whether the publisher server is aware of any active subscriptions, transmit updates to the messaging server. In another embodiment, the messaging server may retrieve media items form the publisher server on an as-needed basis (e.g., when at least one user has subscribed to receive media updates).

The messaging server may also attempt to validate the interest of the other users participating in the conversation. For example, the messaging server may transmit an opt-in or opt-out message 310 to a second client identified in the group list 306. Assuming the user of the second client consents to receiving the updates, the second client ma transmit a confirmation message 312 to the messaging server (if the user does not consent, then either a denial message or no message may be sent, in which case the messaging server may remove the second client from the conversation or refrain from adding the second client to the conversation).

A subscription to receive updates may be associated with a predetermined update period over which updates may be accumulated in a digest. The predetermined update period may be a regular interval over which the updates are transmitted, or may vary according to a schedule. For example, updates may be received more regularly over particularly busy times of day or days of the week. Optionally, the predetermined update period may be user-configurable (e.g., by the user of the first client that initiated the conversation, by a consensus vote of conversation participants, based on the minimum or maximum update period defined by the conversation participants, etc.).

At the end of the predetermined update period, received updates may be aggregated together and transmitted to the conversation participants in a digest. In the example depicted in FIG. 3A, the publisher server transmits a first update 314 to the messaging server, which may include one or more media items. Later, but before the predetermined update period has completed, a second update 316 may be transmitted.

At the end of the predetermined update period, the messaging server may aggregate the updates received from the publisher server (and/or other publisher servers associated with the identified topics and/or the original media item) and may transmit the updates as a digest 318 to the first client and the second client. Optionally, the messaging server may rank the updates received from the publisher server(s) (e.g., based on predicted interest in the items based on the participants in the conversation), and may transmit the updates in a ranked order. Still further, the messaging server may limit the number of media items transmitted in a single digest (e.g., the top n-ranked media items, where n is a predetermined integer).

When the digest is transmitted, a new predetermined update period may begin. In the example depicted in FIG. 3A, a third update 320 is received at the messaging server after the first digest 318 is transmitted. The third update 320 may be included in a future digest at the expiration of the second predetermined update period.

Optionally, a subscription to receive updates may be associated with one or more parameters defining and end of the subscription. For example, the subscription may be ended under certain conditions (e.g., the occurrence or end of an event, after a certain number of digests are transmitted, etc.) or at a certain time (e.g., after a predetermined time interval or at a predetermined end time). At the end of the subscription, the conversation participants may optionally be presented with an opportunity to re-subscribe to the topics of the conversation and/or to subscribe to new topics.

The example operations beginning with the subscription start message 308 and proceeding through the transmission of updates and digests may define a digest-specific processing procedure 322. This type of processing may occur for certain types of subscriptions, such as subscriptions relating to articles or topics. In some embodiments, a participant in the conversation may indicate that they wish to receive digests instead of real-time updates.

Some other types of subscriptions may be better suited to real-time updates, such as live events that occur over a relatively short period of time. In this case, the digest-specific processing 322 may be replaced by event-specific processing 332, as shown in FIG. 3B. This example proceeds in a similar manner to FIG. 3A, except that the messaging server forwards updates to the conversation participants as they are received from the publisher server. For example, when the publisher server transmits a first update 324 to the messaging server, the messaging server forwards the first update 324 to the first and second clients without aggregating the updates into a digest. Similarly, when a second update 326 is received by the messaging server, the messaging server forwards the second update 326.

A subscription including event-specific processing 332 may be associated with an end time or end conditions. When the subscription ends, the messaging server may transmit a termination message 328 to the conversation participants (including the second client, although this is not expressly depicted in FIG. 3B). An example of a termination message 328 is depicted in FIG. 1L.

The termination message 328 may provide the participants with an opportunity to subscribe to receive updates about related topics. Optionally, if one or more of the participants desires to receive the updates, the associated client may transmit a topic subscription message 330 to the messaging server. In response to the topic subscription message, the server may proceed to perform digest-specific processing 322, as shown in FIG. 3A.

FIGS. 3A and 3B depict examples in which a user indicates interest in a media item or topic, and the messaging server suggests a group of participants to participate in a conversation about the media item or topic. As an alternative, the user may participate in a pre-existing conversation, which may be analyzed to identify topics of interest. The messaging server may then recommend topics that the conversation participants may subscribe to. Such an embodiment is depicted in the flow diagram of FIG. 3C.

In this example, a publisher server may periodically send updates 334 to a messaging server. Based on the updates 334, the messaging server may determine which topics are available for discussion and/or which topics are currently trending (e.g., which topics have been most discussed in conversations and/or media items over a predetermined time period).

The messaging server may also receive one or more messages 336 from a client. The messages 336 may relate to a conversation between the client and one or more other clients.

Based on an analysis of trending topics or news, and the topics discussed in the conversation, the messaging server may identify one or more topics that the conversation participants may wish to receive updates on. Accordingly, the messaging server may transmit a subscription recommendation 338 to the clients of the conversation participants (see, e.g., FIG. 1H). One or more participants in the conversation may consent to receive updates, and hence may transmit subscription confirmation messages 340 to the messaging server. If only a subset of the participants consent to receiving updates, the updates may be sent to a new conversation including only those participants who consented to receiving the updates.

Upon receiving a confirmation that the participants will receive updates, processing may then proceed in the form of digest-specific processing 322 (FIG. 3A) or event-specific processing 332 (FIG. 3B), as appropriate.

The embodiments described above may be implemented in suitable logic stored on a non-transitory computer-readable medium. Examples of such logic are next described with reference to FIGS. 4A-4B.

### Exemplary Logic

FIG. 4A is a flowchart depicting exemplary logic 400 for recommending groups and/or topics for which updates may be received. The logic 400 may be implemented on a system, such as a client device, a messaging server, a publisher server, and/or a combination of devices.

At block 402, the system may surface one or more media items in a view depicting the media items. For example, the media items may be depicted in: a conversation view, in which two or more participants participate in a conversation; an inbox view depicting a messaging inbox for a messaging application, in which media items may be displayed along with messages and/or conversation threads (corresponding e.g. to FIG. 1B); an article view relating to a conversation between users of the messaging service that have reacted to the media (block 404, corresponding e.g. to FIG. 1E); a chat room view in which two or more participants enter an area designated for conversing about one or more topics (block 406, corresponding e.g. to FIG. 1F), or a media view depicting a number of media items predicted to be of interest to the user (block 408, corresponding e.g. to FIG. 1C).

Optionally, the media item may be associated with an event, such as a live event occurring on a social network. For example, the media item may be an invitation to an event or a post from a social networking page related to the event. Alternatively or in addition, the media item may mention an event, may be published by a publisher associated with an event, or may otherwise be affiliated with an event.

At block 410, the system may receive an indication of interest in the media item surfaced at block 402. The indication of interest may be an express indication of interest, such as when a user interacts with a conversation interface element to manually initiate a conversation about the media, or when the user otherwise instructs the system to begin a conversation about the media item (e.g., as shown in FIG. 1D). The indication of interest may also be an implicit indication of interest, such as when the user accesses the media item, shares the media item, reacts to the media item, or comments on the media item, among other possibilities.

In order to prevent spam, the system may proceed to make recommendations based on the indication of interest only under certain circumstances (e.g., when the indication of interest is an express indication of interest or the system receives an implicit indication of interest and other factors, such as user preferences or conversation history, indicates that the user is likely to wish to begin a conversation relating to the media item).

At block 412, the system may identify one or more topics related to the media item. The topics may be identified expressly by the publisher of the media item and/or consumers of the media item (e.g., by tagging the media item with one or more topic tags). Alternatively or in addition, the system may automatically tag the media item based on, e.g., textual, visual, and/or audio analysis of the media item. Still further, other information associated with the media item may be used to determine the topics related to the media item, such as interests shared by the predominate consumers of the media item, comments on the media item, etc.

At block 414, the system may identify one or more participants to participate in a conversation about the media item and/or topic(s). The system may access one or more lists of the original user's (i.e., the user to whom the media was surfaced at block 402) contacts or friends. The candidate participants may include contacts in the user's contacts list (e.g., as stored on the user's mobile device), contacts in a messaging service, friends in a social networking service, etc.

The initial candidate list may be filtered and/or ranked based on the likelihood that the user would be interested in conversing with the candidate participant (e.g., an affinity of the original user for the candidate and/or vice versa) and/or a likelihood that the candidate participant will be interested in discussing the media and/or topic(s) identified at block 412. For example, the system may evaluate the candidate participants' interests as reflected by connections and/or affinities in a social graph (see FIG. 5C). The system may also or alternatively analyze conversations in which the candidate user participates, if authorized to do so by the candidate user, to determine the user's interests and preferences.

Based on the analysis of likely participants, the system may present a ranked list of the candidates to the original user for selection of a group of participants to participate in the conversation (see, e.g., FIG. 1G). The system may receive a selection of participants from the original user, which may form the participant list for the conversation. The system may generate a thread identifier and associate the thread ID with the participant list.

Alternatively, the conversation may take place between the original user who viewed the media in block 402 and a publisher of the media, or may be a one-on-one conversation between the user and another designated user.

At block 416, the system may determine whether the original media or identified topic(s) relate(s) to an event, such as live event. For example, the media or topics may be flagged as being associated with an event. Alternatively or in addition, the media may be analyzed or classified (e.g., based on textual analysis and/or a keyword search) to determine whether the media focuses on or is otherwise related to a live event. Still further, the original user may flag their interest in a particular event discussed in the media.

If the determination at block 416 is “no” (i.e., the media does not relate to an event), then at block 418, the system may aggregate media items over a predetermined period of time, as described in connection with FIG. 3A. At block 420, the system may periodically transmit digests, which include a collection of media items aggregated in block 418.

At block 422, the system may determine whether updates have been canceled. For example, updates may be canceled upon action of one or more of the participants in the conversation. Alternatively or in addition, the updates may be configured to expire after a user-specified, publisher-specified, or predetermined period of time.

If the determination at block 422 is “yes” (i.e., updates have been canceled), then processing may proceed to block 424 and terminate. Optionally, the system may present a termination message and allow the users to subscribe to further related topics (see, e.g., blocks 430 and 432).

If the determination at block 422 is “no” (i.e., the updates have not been canceled), then processing may return to block 418 and the system may begin aggregating further media items for a new digest.

Returning to block 416, if the determination at this block is “yes” (i.e., the media relates to an event), then at block 426, the system may transmit updates in real- or near-real-time, as described in connection with FIG. 3B. At block 428, the system may determine whether the event has ended (or other predetermined termination conditions have occurred). If not, then processing may return to block 426 and further updates may be transmitted. If so, then processing may proceed to block 430.

At block 430, the system may transmit a message indicating that the event has concluded and that the user is no longer subscribed to receive updates. The message may present an option to subscribe in order to continue to receive updates about one or more designated topics.

At block 432, the system may determine whether the conversation participant(s) have subscribed to receive topic updates. If so, processing may proceed to block 418, and the system may begin aggregating media items for transmission in digest form. If not, then processing may proceed to block 424 and terminate.

The processing blocks 416-432 may form update logic 434, which may be used in a variety of contexts. For example, FIG. 4B is a flowchart depicting exemplary logic 450 for analyzing a conversation to recommend topics for which updates may be received.

At block 452, the system may access a conversation associated with an original user. The conversation may be an active conversation in the messaging system. In some embodiments, the system may access only recent messages of the conversation (e.g., messages transmitted on the messaging service within a predetermined period of time).

At block 454, the system may analyze the retrieved messages of the conversation. For example, the system may perform textual analysis on the message content of the conversation, may perform visual or audio analysis of content shared in the conversation, and/or may analyze any media items linked in the conversation.

The system may furthermore analyze trending topics as determined in information accessed from outside the conversation (e.g., through third-party news sources, through a social network, etc.).

Based on either or a combination of the analysis of the conversation and/or trending topics, the system may identify one or more topics to which the user may wish to subscribe in block 456. The topics may be, for example, topics discussed in the conversation for which the analysis of third-party sources indicates other users are also engaging with in other conversations and/or topics which are being discussed in the news or other sources.

At block 458, the system may recommend the topics in the conversation for subscription and/or further discussion. For example, the system may transmit a message into the conversation, as shown for example in FIG. 1H.

At block 460, the system may receive an indication of interest in subscribing to one or more of the topics. For example, one or more of the conversation participants may elect to receive updates in response to the message transmitted in block 458. If some but not all of the conversation participants elect to receive updates, then a new conversation may be started (with a new thread ID) for those participants electing to receive updates.

Processing may then proceed to block 434 (see FIG. 4A).

These examples may be implemented by a messaging system that is provided either locally, at a client device, or remotely (e.g., at a remote server). FIGS. 5A-5C depict various examples of messaging systems, and are discussed in more detail below.

### Messaging System Overview

FIG. 5A depicts an exemplary centralized messaging system 500, in which functionality for organizing messages asynchronously and/or using threads is integrated into a messaging server. The centralized system 500 may implement some or all of the structure and/or operations of a messaging service in a single computing entity, such as entirely within a single centralized server device 526.

The messaging system 500 may include a computer-implemented system having software applications that include one or more components. Although the messaging system 500 shown in FIG. 5A has a limited number of elements in a certain topology, the messaging system 500 may include more or fewer elements in alternate topologies.

A messaging service 500 may be generally arranged to receive, store, and deliver messages. The messaging service 500 may store messages while messaging clients 520, such as may execute on client devices 510, are offline and deliver the messages once the messaging clients are available.

A client device 510 may transmit messages addressed to a recipient user, user account, or other identifier resolving to a receiving client device 510. In exemplary embodiments, each of the client devices 510 and their respective messaging clients 520 are associated with a particular user or users of the messaging service 500. In some embodiments, the client devices 510 may be cellular devices such as smartphones and may be identified to the messaging service 500 based on a phone number associated with each of the client devices 510. In some embodiments, each messaging client may be associated with a user account registered with the messaging service 500. In general, each messaging client may be addressed through various techniques for the reception of messages. While in some embodiments the client devices 510 may be cellular devices, in other embodiments one or more of the client devices 510 may be personal computers, tablet devices, any other form of computing device.

The client 510 may include one or more input devices 512 and one or more output devices 518. The input devices 512 may include, for example, microphones, keyboards, cameras, electronic pens, touch screens, and other devices for receiving inputs including message data, requests, commands, user interface interactions, selections, and other types of input. The output devices 518 may include a speaker, a display device such as a monitor or touch screen, and other devices for presenting an interface to the messaging system 500.

The client 510 may include a memory 519, which may be a non-transitory computer readable storage medium, such as one or a combination of a hard drive, solid state drive, flash storage, read only memory, or random access memory. The memory 519 may a representation of an input 514 and/or a representation of an output 516, as well as one or more applications. For example, the memory 519 may store a messaging client 520 and/or a social networking client that allows a user to interact with a social networking service.

The input 514 may be textual, such as in the case where the input device 212 is a keyboard. Alternatively, the input 514 may be an audio recording, such as in the case where the input device 512 is a microphone. Accordingly, the input 514 may be subjected to automatic speech recognition (ASR) logic in order to transform the audio recording to text that is processable by the messaging system 500. The ASR logic may be located at the client device 510 (so that the audio recording is processed locally by the client 510 and corresponding text is transmitted to the messaging server 526), or may be located remotely at the messaging server 526 (in which case, the audio recording may be transmitted to the messaging server 526 and the messaging server 526 may process the audio into text). Other combinations are also possible—for example, if the input device 512 is a touch pad or electronic pen, the input 514 may be in the form of handwriting, which may be subjected to handwriting or optical character recognition analysis logic in order to transform the input 512 into processable text.

The client 510 may be provided with a network interface 522 for communicating with a network 524, such as the Internet. The network interface 522 may transmit the input 512 in a format and/or using a protocol compatible with the network 524 and may receive a corresponding output 516 from the network 524.

The network interface 522 may communicate through the network 524 to a messaging server 526. The messaging server 526 may be operative to receive, store, and forward messages between messaging clients.

The messaging server 526 may include a network interface 522, messaging preferences 528, and communications logic 530. The messaging preferences 528 may include one or more privacy settings or other preferences for one or more users and/or message threads. Furthermore, the messaging preferences 528 may include one or more settings, including default settings, for the logic described herein.

The communications logic 530 may include topic update and recommendation logic 532 that is operable to analyze a conversation and recommend topics of interest for which the conversation participants may be interested in receiving updates. The communications logic 530 may further include group recommendation and update 534 that is operable to identify topics discussed in media items and recommend conversation participants based on the identified topics.

The network interface 522 of the client 510 and/or the messaging server 526 may also be used to communicate through the network 524 with a social networking server 536. The social networking server 536 may include or may interact with a social networking graph 538 that defines connections in a social network. Furthermore, the messaging server 526 may connect to the social networking server 536 for various purposes, such as retrieving connection information, messaging history, event details, etc. from the social network.

A user of the client 510 may be an individual (human user), an entity (e.g., an enterprise, business, or third-party application), or a group (e.g., of individuals or entities) that interacts or communicates with or over the social networking server 536. The social-networking server 536 may be a network-addressable computing system hosting an online social network. The social networking server 536 may generate, store, receive, and send social-networking data, such as, for example, user-profile data, concept-profile data, social-graph information, or other suitable data related to the online social network. The social networking server 536 may be accessed by the other components of the network environment either directly or via the network 524.

The social networking server 536 may include an authorization server (or other suitable component(s)) that allows users to opt in to or opt out of having their actions logged by social-networking server 536 or shared with other systems (e.g., third-party systems, such as the messaging server 526), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking server 536 through blocking, data hashing, anonymization, or other suitable techniques as appropriate.

More specifically, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums).

In particular embodiments, privacy settings may be associated with particular elements of the social networking graph 538. Privacy settings of a social-graph element, such as a node or an edge, may specify how the social-graph element, information associated with the social-graph element, or content objects associated with the social-graph element can be accessed using the online social network. As an example and not by way of limitation, a particular concept node corresponding to a particular photo may have a privacy setting specifying that the photo may only be accessed by users tagged in the photo and their friends. In particular embodiments, privacy settings may allow users to opt in or opt out of having their actions logged by social networking server 536 or shared with other systems. In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In response to a request from a user (or other entity) for a particular object stored in a data store, the social networking server 536 may send a request to the data store for the object. The request may identify the user associated with the request. The requested data object may only be sent to the user (or a client system 510 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results.

In some embodiments, targeting criteria may be used to identify users of the social network for various purposes. Targeting criteria used to identify and target users may include explicit, stated user interests on social-networking server 536 or explicit connections of a user to a node, object, entity, brand, or page on social networking server 536. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also implicate privacy settings (such as user opt-outs), data hashing, or data anonymization, as appropriate.

The centralized embodiment depicted in FIG. 5A may be well-suited to deployment as a new system or as an upgrade to an existing system, because the logic for pivoting to a group conversation (e.g., the logic of the intent determination component 532 and/or the logic of the group selection component 534) are incorporated into the messaging server 526. In contrast, FIG. 5B depicts an exemplary distributed messaging system 550, in which functionality for in which functionality for processing updates is distributed and remotely accessible from the messaging server. Examples of a distributed system 550 include a client-server architecture, a 3-tier architecture, an N-tier architecture, a tightly-coupled or clustered architecture, a peer-to-peer architecture, a master-slave architecture, a shared database architecture, and other types of distributed systems.

Many of the components depicted in FIG. 5B are identical to those in FIG. 5A, and a description of these elements is not repeated here for the sake of brevity. The primary difference between the centralized embodiment and the distributed embodiment is the addition of a separate update server 552, which hosts the topic recommendation and update logic 532 and the group recommendation and update logic 534. The update server 552 may be distinct from the messaging server 526 but may communicate with the messaging server 526, either directly or through the network 524, to provide the functionality of the logic 532 and the logic 534 to the messaging server 526.

The embodiment depicted in FIG. 5B may be particularly well suited to allow exemplary embodiments to be deployed alongside existing messaging systems, for example when it is difficult or undesirable to replace an existing messaging server. Additionally, in some cases the messaging server 526 may have limited resources (e.g. processing or memory resources) that limit or preclude the addition of the additional pivot functionality. In such situations, the capabilities described herein may still be provided through the separate update server 552.

In still further embodiments, the logic 532 and the logic 534 may be provided locally at the client 510-i, for example as part of the messaging client 520. In these embodiments, each client 510-i makes its own determination as to which messages belong to which thread, and how to update the display and issue notifications. As a result, different clients 510-i may display the same conversation differently, depending on local settings (for example, the same messages may be assigned to different threads, or similar threads may have different parents or highlights).

FIG. 5C illustrates an example of a social networking graph 538. In exemplary embodiments, a social networking service may store one or more social graphs 538 in one or more data stores as a social graph data structure via the social networking service.

The social graph 538 may include multiple nodes, such as user nodes 554 and concept nodes 556. The social graph 228 may furthermore include edges 558 connecting the nodes. The nodes and edges of social graph 228 may be stored as data objects, for example, in a data store (such as a social-graph database). Such a data store may include one or more searchable or queryable indexes of nodes or edges of social graph 228.

The social graph 538 may be accessed by a social-networking server 226, client system 210, third-party system (e.g., the translation server 224), or any other approved system or device for suitable applications.

A user node 554 may correspond to a user of the social-networking system. A user may be an individual (human user), an entity (e.g., an enterprise, business, or third-party application), or a group (e.g., of individuals or entities) that interacts or communicates with or over the social-networking system. In exemplary embodiments, when a user registers for an account with the social-networking system, the social-networking system may create a user node 554 corresponding to the user, and store the user node 30 in one or more data stores. Users and user nodes 554 described herein may, where appropriate, refer to registered users and user nodes 554 associated with registered users. In addition or as an alternative, users and user nodes 554 described herein may, where appropriate, refer to users that have not registered with the social-networking system. In particular embodiments, a user node 554 may be associated with information provided by a user or information gathered by various systems, including the social-networking system. As an example and not by way of limitation, a user may provide their name, profile picture, contact information, birth date, sex, marital status, family status, employment, education background, preferences, interests, or other demographic information. In particular embodiments, a user node 554 may be associated with one or more data objects corresponding to information associated with a user. In particular embodiments, a user node 554 may correspond to one or more webpages. A user node 554 may be associated with a unique user identifier for the user in the social-networking system.

In particular embodiments, a concept node 556 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking system or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 556 may be associated with information of a concept provided by a user or information gathered by various systems, including the social-networking system. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 556 may be associated with one or more data objects corresponding to information associated with concept node 556. In particular embodiments, a concept node 556 may correspond to one or more webpages.

In particular embodiments, a node in social graph 538 may represent or be represented by a webpage (which may be referred to as a “profile page”). Profile pages may be hosted by or accessible to the social-networking system. Profile pages may also be hosted on third-party websites associated with a third-party server. As an example and not by way of limitation, a profile page corresponding to a particular external webpage may be the particular external webpage and the profile page may correspond to a particular concept node 556. Profile pages may be viewable by all or a selected subset of other users. As an example and not by way of limitation, a user node 554 may have a corresponding user-profile page in which the corresponding user may add content, make declarations, or otherwise express himself or herself. A business page such as business page 205 may comprise a user-profile page for a commerce entity. As another example and not by way of limitation, a concept node 556 may have a corresponding concept-profile page in which one or more users may add content, make declarations, or express themselves, particularly in relation to the concept corresponding to concept node 556.

In particular embodiments, a concept node 556 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking system a message indicating the user's action. In response to the message, the social-networking system may create an edge (e.g., an “eat” edge) between a user node 554 corresponding to the user and a concept node 556 corresponding to the third-party webpage or resource and store edge 558 in one or more data stores.

In particular embodiments, a pair of nodes in social graph 538 may be connected to each other by one or more edges 558. An edge 558 connecting a pair of nodes may represent a relationship between the pair of nodes. In particular embodiments, an edge 558 may include or represent one or more data objects or attributes corresponding to the relationship between a pair of nodes. As an example and not by way of limitation, a first user may indicate that a second user is a “friend” of the first user. In response to this indication, the social-networking system may send a “friend request” to the second user. If the second user confirms the “friend request,” the social-networking system may create an edge 558 connecting the first user's user node 554 to the second user's user node 554 in social graph 538 and store edge 558 as social-graph information in one or more data stores. In the example of FIG. 5C, social graph 538 includes an edge 558 indicating a friend relation between user nodes 554 of user “Amanda” and user “Dorothy.” Although this disclosure describes or illustrates particular edges 558 with particular attributes connecting particular user nodes 554, this disclosure contemplates any suitable edges 558 with any suitable attributes connecting user nodes 554. As an example and not by way of limitation, an edge 558 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 538 by one or more edges 558.

In particular embodiments, an edge 558 between a user node 554 and a concept node 556 may represent a particular action or activity performed by a user associated with user node 554 toward a concept associated with a concept node 556. As an example and not by way of limitation, as illustrated in FIG. 5C, a user may “like,” “attended,” “played,” “listened,” “cooked,” “worked at,” or “watched” a concept, each of which may correspond to a edge type or subtype. A concept-profile page corresponding to a concept node 556 may include, for example, a selectable “check in” icon (such as, for example, a clickable “check in” icon) or a selectable “add to favorites” icon. Similarly, after a user clicks these icons, the social-networking system may create a “favorite” edge or a “check in” edge in response to a user's action corresponding to a respective action. As another example and not by way of limitation, a user (user “Carla”) may listen to a particular song (“Across the Sea”) using a particular application (SPOTIFY, which is an online music application). In this case, the social-networking system may create a “listened” edge 558 and a “used” edge (as illustrated in FIG. 5C) between user nodes 554 corresponding to the user and concept nodes 556 corresponding to the song and application to indicate that the user listened to the song and used the application. Moreover, the social-networking system may create a “played” edge 558 (as illustrated in FIG. 5C) between concept nodes 556 corresponding to the song and the application to indicate that the particular song was played by the particular application. In this case, “played” edge 558 corresponds to an action performed by an external application (SPOTIFY) on an external audio file (the song “Across the Sea”). Although this disclosure describes particular edges 558 with particular attributes connecting user nodes 554 and concept nodes 556, this disclosure contemplates any suitable edges 558 with any suitable attributes connecting user nodes 554 and concept nodes 556. Moreover, although this disclosure describes edges between a user node 554 and a concept node 556 representing a single relationship, this disclosure contemplates edges between a user node 554 and a concept node 556 representing one or more relationships. As an example and not by way of limitation, an edge 558 may represent both that a user likes and has used at a particular concept. Alternatively, another edge 558 may represent each type of relationship (or multiples of a single relationship) between a user node 554 and a concept node 556 (as illustrated in FIG. 5C between user node 554 for user “Edwin” and concept node 556 for “SPOTIFY”).

In particular embodiments, the social-networking system may create an edge 558 between a user node 554 and a concept node 556 in social graph 538. As an example and not by way of limitation, a user viewing a concept-profile page (such as, for example, by using a web browser or a special-purpose application hosted by the user's client system) may indicate that he or she likes the concept represented by the concept node 556 by clicking or selecting a “Like” icon, which may cause the user's client system to send to the social-networking system a message indicating the user's liking of the concept associated with the concept-profile page. In response to the message, the social-networking system may create an edge 558 between user node 554 associated with the user and concept node 556, as illustrated by “like” edge 558 between the user and concept node 556. In particular embodiments, the social-networking system may store an edge 558 in one or more data stores. In particular embodiments, an edge 558 may be automatically formed by the social-networking system in response to a particular user action. As an example and not by way of limitation, if a first user uploads a picture, watches a movie, or listens to a song, an edge 558 may be formed between user node 554 corresponding to the first user and concept nodes 556 corresponding to those concepts. Although this disclosure describes forming particular edges 558 in particular manners, this disclosure contemplates forming any suitable edges 558 in any suitable manner.

The social graph 538 may further comprise a plurality of product nodes. Product nodes may represent particular products that may be associated with a particular business. A business may provide a product catalog to a consumer-to-business service and the consumer-to-business service may therefore represent each of the products within the product in the social graph 538 with each product being in a distinct product node. A product node may comprise information relating to the product, such as pricing information, descriptive information, manufacturer information, availability information, and other relevant information. For example, each of the items on a menu for a restaurant may be represented within the social graph 538 with a product node describing each of the items. A product node may be linked by an edge to the business providing the product. Where multiple businesses provide a product, each business may have a distinct product node associated with its providing of the product or may each link to the same product node. A product node may be linked by an edge to each user that has purchased, rated, owns, recommended, or viewed the product, with the edge describing the nature of the relationship (e.g., purchased, rated, owns, recommended, viewed, or other relationship). Each of the product nodes may be associated with a graph id and an associated merchant id by virtue of the linked merchant business. Products available from a business may therefore be communicated to a user by retrieving the available product nodes linked to the user node for the business within the social graph 538. The information for a product node may be manipulated by the social-networking system as a product object that encapsulates information regarding the referenced product.

As such, the social graph 538 may be used to infer shared interests, shared experiences, or other shared or common attributes of two or more users of a social-networking system. For instance, two or more users each having an edge to a common business, product, media item, institution, or other entity represented in the social graph 538 may indicate a shared relationship with that entity, which may be used to suggest customization of a use of a social-networking system, including a messaging system, for one or more users.

### Messaging Architecture

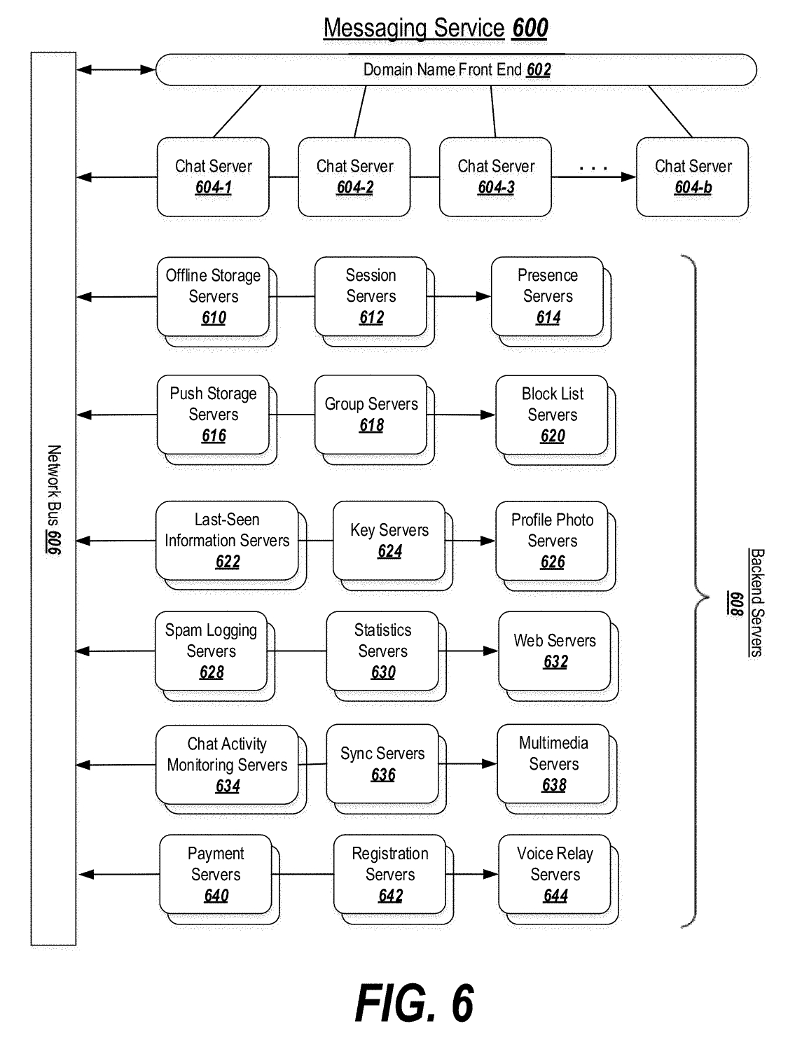

FIG. 6 illustrates an embodiment of a plurality of servers implementing various functions of a messaging service 600. It will be appreciated that different distributions of work and functions may be used in various embodiments of a messaging service 600.

The messaging service 600 may comprise a domain name front end 602. The domain name front end 602 may be assigned one or more domain names associated with the messaging service 600 in a domain name system (DNS). The domain name front end 602 may receive incoming connections and distribute the connections to servers providing various messaging services.

The messaging service 602 may comprise one or more chat servers 604. The chat servers 604 may comprise front-end servers for receiving and transmitting user-to-user messaging updates such as chat messages. Incoming connections may be assigned to the chat servers 604 by the domain name front end 602 based on workload balancing.

The messaging service 600 may comprise backend servers 608. The backend servers 608 may perform specialized tasks in the support of the chat operations of the front-end chat servers 604. A plurality of different types of backend servers 608 may be used. It will be appreciated that the assignment of types of tasks to different backend serves 608 may vary in different embodiments. In some embodiments some of the back-end services provided by dedicated servers may be combined onto a single server or a set of servers each performing multiple tasks divided between different servers in the embodiment described herein. Similarly, in some embodiments tasks of some of dedicated back-end servers described herein may be divided between different servers of different server groups.

The messaging service 600 may comprise one or more offline storage servers 610. The one or more offline storage servers 610 may store messaging content for currently-offline messaging clients in hold for when the messaging clients reconnect.

The messaging service 600 may comprise one or more sessions servers 612. The one or more session servers 612 may maintain session state of connected messaging clients.

The messaging service 600 may comprise one or more presence servers 614. The one or more presence servers 614 may maintain presence information for the messaging service 600. Presence information may correspond to user-specific information indicating whether or not a given user has an online messaging client and is available for chatting, has an online messaging client but is currently away from it, does not have an online messaging client, and any other presence state.

The messaging service 600 may comprise one or more push storage servers 616. The one or more push storage servers 616 may cache push requests and transmit the push requests to messaging clients. Push requests may be used to wake messaging clients, to notify messaging clients that a messaging update is available, and to otherwise perform server-side-driven interactions with messaging clients.

The messaging service 600 may comprise one or more group servers 618. The one or more group servers 618 may maintain lists of groups, add users to groups, remove users from groups, and perform the reception, caching, and forwarding of group chat messages.

The messaging service 600 may comprise one or more block list servers 620. The one or more block list servers 620 may maintain user-specific block lists, the user-specific incoming-block lists indicating for each user the one or more other users that are forbidden from transmitting messages to that user. Alternatively or additionally, the one or more block list servers 620 may maintain user-specific outgoing-block lists indicating for each user the one or more other users that that user is forbidden from transmitting messages to. It will be appreciated that incoming-block lists and outgoing-block lists may be stored in combination in, for example, a database, with the incoming-block lists and outgoing-block lists representing different views of a same repository of block information.

The messaging service 600 may comprise one or more last seen information servers 622. The one or more last seen information servers 622 may receive, store, and maintain information indicating the last seen location, status, messaging client, and other elements of a user's last seen connection to the messaging service 600.

The messaging service 600 may comprise one or more key servers 624. The one or more key servers may host public keys for public/private key encrypted communication.

The messaging service 600 may comprise one or more profile photo servers 626. The one or more profile photo servers 626 may store and make available for retrieval profile photos for the plurality of users of the messaging service 600.

The messaging service 600 may comprise one or more spam logging servers 628. The one or more spam logging servers 628 may log known and suspected spam (e.g., unwanted messages, particularly those of a promotional nature). The one or more spam logging servers 628 may be operative to analyze messages to determine whether they are spam and to perform punitive measures, in some embodiments, against suspected spammers (users that send spam messages).

The messaging service 600 may comprise one or more statistics servers 630. The one or more statistics servers may compile and store statistics information related to the operation of the messaging service 600 and the behavior of the users of the messaging service 600.

The messaging service 600 may comprise one or more web servers 632. The one or more web servers 632 may engage in hypertext transport protocol (HTTP) and hypertext transport protocol secure (HTTPS) connections with web browsers.

The messaging service 600 may comprise one or more chat activity monitoring servers 634. The one or more chat activity monitoring servers 634 may monitor the chats of users to determine unauthorized or discouraged behavior by the users of the messaging service 600. The one or more chat activity monitoring servers 634 may work in cooperation with the spam logging servers 628 and block list servers 620, with the one or more chat activity monitoring servers 634 identifying spam or other discouraged behavior and providing spam information to the spam logging servers 628 and blocking information, where appropriate to the block list servers 620.

The messaging service 600 may comprise one or more sync servers 636. The one or more sync servers 636 may sync the communication system 500 with contact information from a messaging client, such as an address book on a mobile phone, to determine contacts for a user in the messaging service 600.

The messaging service 600 may comprise one or more multimedia servers 638. The one or more multimedia servers may store multimedia (e.g., images, video, audio) in transit between messaging clients, multimedia cached for offline endpoints, and may perform transcoding of multimedia.

The messaging service 600 may comprise one or more payment servers 640. The one or more payment servers 640 may process payments from users. The one or more payment servers 640 may connect to external third-party servers for the performance of payments.

The messaging service 600 may comprise one or more registration servers 642. The one or more registration servers 642 may register new users of the messaging service 600.

The messaging service 600 may comprise one or more voice relay servers 644. The one or more voice relay servers 644 may relay voice-over-Internet-protocol (VoIP) voice communication between messaging clients for the performance of VoIP calls.

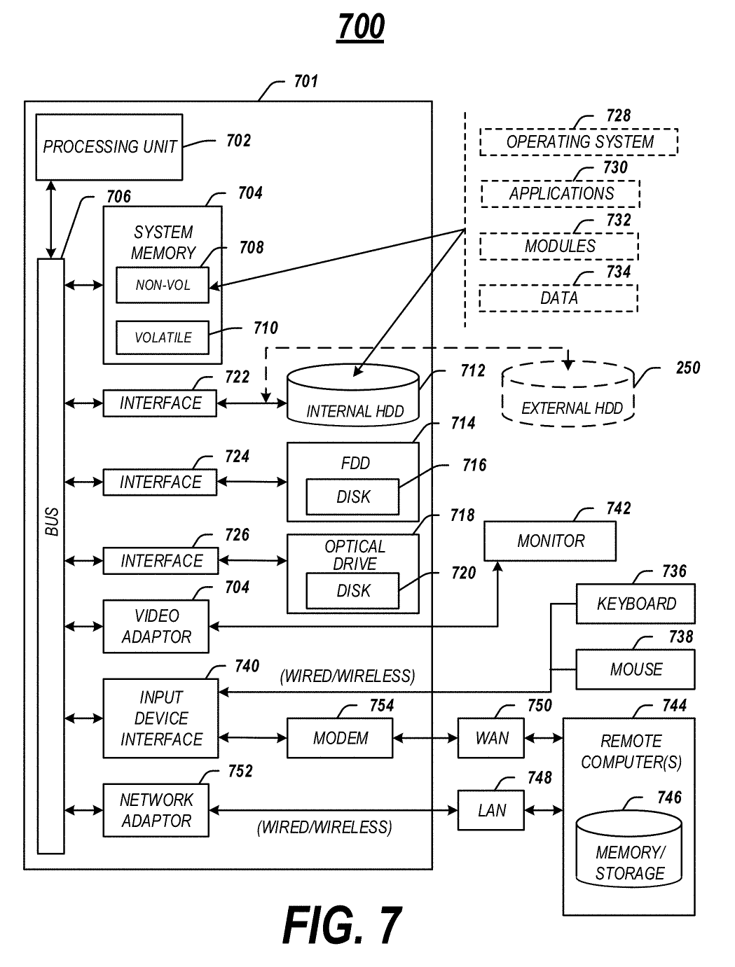

The above-described methods may be embodied as instructions on a computer readable medium or as part of a computing architecture. FIG. 7 illustrates an embodiment of an exemplary computing architecture 700 suitable for implementing various embodiments as previously described. In one embodiment, the computing architecture 700 may comprise or be implemented as part of an electronic device, such as a computer 701. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 702, a system memory 704 and a system bus 706. The processing unit 702 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 702.

The system bus 706 provides an interface for system components including, but not limited to, the system memory 704 to the processing unit 702. The system bus 706 can be any of several types of bus structure that may further interconnect to a memory bus (with or without a memory controller), a peripheral bus, and a local bus using any of a variety of commercially available bus architectures. Interface adapters may connect to the system bus 706 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile memory 708 and/or volatile memory 710. A basic input/output system (BIOS) can be stored in the non-volatile memory 708.

The computing architecture 700 may include various types of computer-readable storage media in the form of one or more lower speed memory units, including an internal (or external) hard disk drive (HDD) 712, a magnetic floppy disk drive (FDD) 714 to read from or write to a removable magnetic disk 716, and an optical disk drive 718 to read from or write to a removable optical disk 720 (e.g., a CD-ROM or DVD). The HDD 712, FDD 714 and optical disk drive 720 can be connected to the system bus 706 by an HDD interface 722, an FDD interface 724 and an optical drive interface 726, respectively. The HDD interface 722 for external drive implementations can include at least one or both of Universal Serial Bus (USB) and IEEE 694 interface technologies.

The drives and associated computer-readable media provide volatile and/or nonvolatile storage of data, data structures, computer-executable instructions, and so forth. For example, a number of program modules can be stored in the drives and memory units 708, 712, including an operating system 728, one or more application programs 730, other program modules 732, and program data 734. In one embodiment, the one or more application programs 730, other program modules 732, and program data 734 can include, for example, the various applications and/or components of the communication system 500.

A user can enter commands and information into the computer 701 through one or more wire/wireless input devices, for example, a keyboard 736 and a pointing device, such as a mouse 738. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 702 through an input device interface 740 that is coupled to the system bus 706, but can be connected by other interfaces such as a parallel port, IEEE 694 serial port, a game port, a USB port, an IR interface, and so forth.

A monitor 742 or other type of display device is also connected to the system bus 706 via an interface, such as a video adaptor 744. The monitor 742 may be internal or external to the computer 701. In addition to the monitor 742, a computer typically includes other peripheral output devices, such as speakers, printers, and so forth.

The computer 701 may operate in a networked environment using logical connections via wire and/or wireless communications to one or more remote computers, such as a remote computer 744. The remote computer 744 can be a workstation, a server computer, a router, a personal computer, portable computer, microprocessor-based entertainment appliance, a peer device or other common network node, and typically includes many or all of the elements described relative to the computer 701, although, for purposes of brevity, only a memory/storage device 746 is illustrated. The logical connections depicted include wire/wireless connectivity to a local area network (LAN) 748 and/or larger networks, for example, a wide area network (WAN) 750. Such LAN and WAN networking environments are commonplace in offices and companies, and facilitate enterprise-wide computer networks, such as intranets, all of which may connect to a global communications network, for example, the Internet.

When used in a LAN networking environment, the computer 701 is connected to the LAN 748 through a wire and/or wireless communication network interface or adaptor 752. The adaptor 752 can facilitate wire and/or wireless communications to the LAN 748, which may also include a wireless access point disposed thereon for communicating with the wireless functionality of the adaptor 752.

When used in a WAN networking environment, the computer 701 can include a modem 754, or is connected to a communications server on the WAN 750, or has other means for establishing communications over the WAN 750, such as by way of the Internet. The modem 754, which can be internal or external and a wire and/or wireless device, connects to the system bus 706 via the input device interface 740. In a networked environment, program modules depicted relative to the computer 701, or portions thereof, can be stored in the remote memory/storage device 746. It will be appreciated that the network connections shown are exemplary and other means of establishing a communications link between the computers can be used.

The computer 701 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

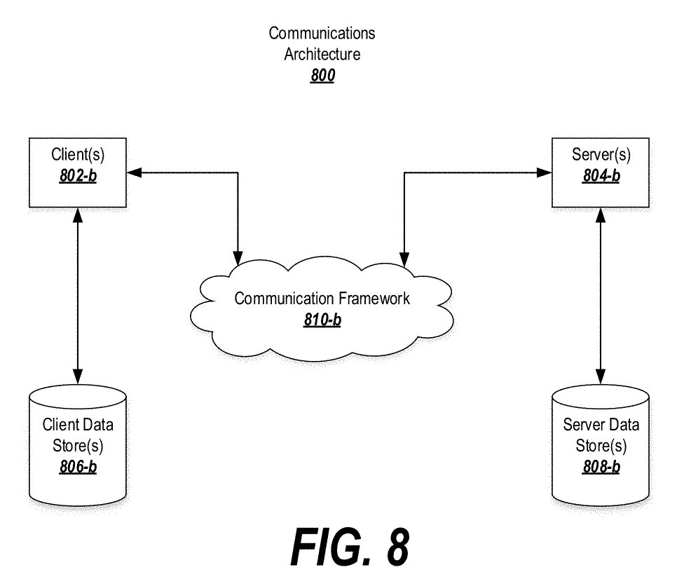

FIG. 8 is a block diagram depicting an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The clients 802 may implement the client device 510. The servers 804 may implement the server device 526. The clients 802 and the servers 804 are operatively connected to one or more respective client data stores 806 and server data stores 808 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.8a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

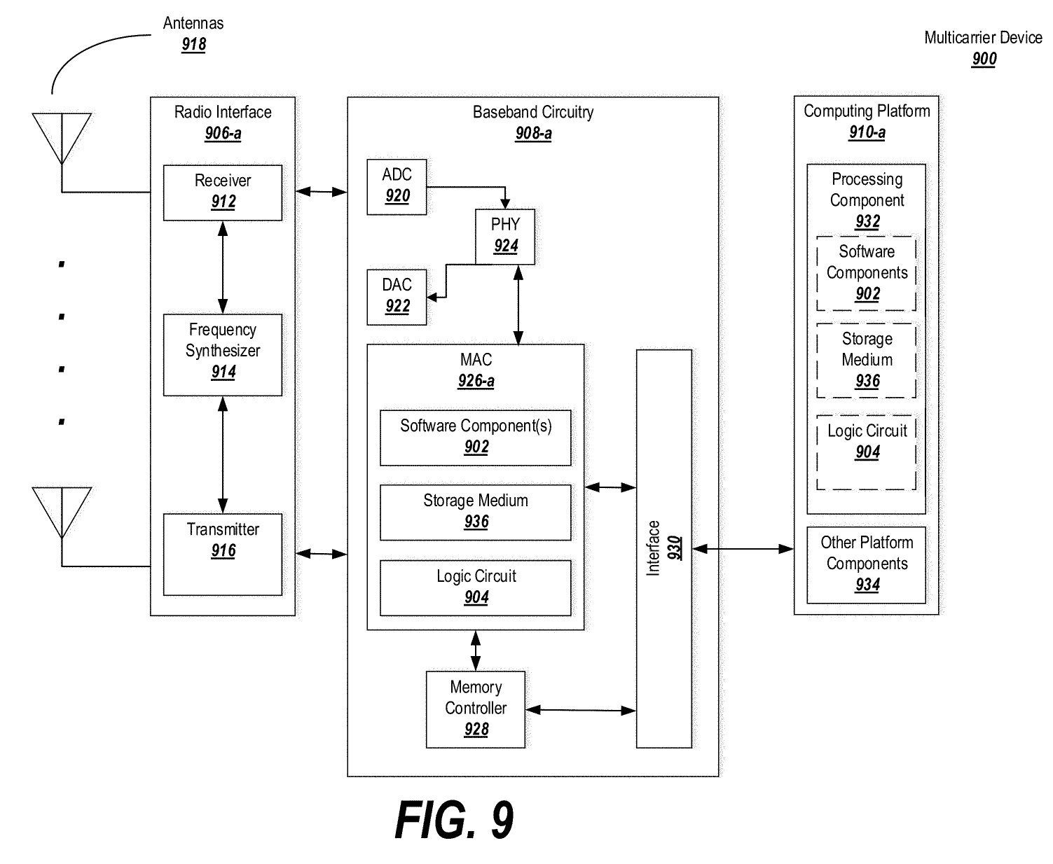

FIG. 9 illustrates an embodiment of a device 900 for use in a multicarrier OFDM system, such as the communication system 500. The device 900 may implement, for example, software components 902 as described with reference to the messaging component logic 600, the intent determination logic 700, and the group selection logic 800. The device 900 may also implement a logic circuit 904. The logic circuit 904 may include physical circuits to perform operations described for the messaging system 600. As shown in FIG. 9, device 900 may include a radio interface 906, baseband circuitry 908, and a computing platform 910, although embodiments are not limited to this configuration.

The device 900 may implement some or all of the structure and/or operations for the communication system 500 and/or logic circuit 904 in a single computing entity, such as entirely within a single device. Alternatively, the device 900 may distribute portions of the structure and/or operations for the messaging system 600 and/or logic circuit 904 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, the radio interface 906 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. The radio interface 906 may include, for example, a receiver 912, a transmitter 914 and/or a frequency synthesizer 916. The radio interface 906 may include bias controls, a crystal oscillator and/or one or more antennas 918. In another embodiment, the radio interface 906 may use external voltage-controlled oscillators (VCOs), surface acoustic wave filters, intermediate frequency (IF) filters and/or RF filters, as desired. Due to the variety of potential RF interface designs an expansive description thereof is omitted.

The baseband circuitry 908 may communicate with the radio interface 906 to process receive and/or transmit signals and may include, for example, an analog-to-digital converter 920 for down converting received signals, and a digital-to-analog converter 922 for up-converting signals for transmission. Further, the baseband circuitry 908 may include a baseband or physical layer (PHY) processing circuit 924 for PHY link layer processing of respective receive/transmit signals. The baseband circuitry 908 may include, for example, a processing circuit 926 for medium access control (MAC)/data link layer processing. The baseband circuitry 908 may include a memory controller 928 for communicating with the processing circuit 926 and/or a computing platform 910, for example, via one or more interfaces 930.

In some embodiments, the PHY processing circuit 924 may include a frame construction and/or detection module, in combination with additional circuitry such as a buffer memory, to construct and/or deconstruct communication frames, such as radio frames. Alternatively or in addition, the MAC processing circuit 926 may share processing for certain of these functions or perform these processes independent of the PHY processing circuit 924. In some embodiments, MAC and PHY processing may be integrated into a single circuit.

The computing platform 910 may provide computing functionality for the device 900. As shown, the computing platform 910 may include a processing component 932. In addition to, or alternatively of, the baseband circuitry 908, the device 900 may execute processing operations or logic for the communication system 500 and logic circuit 904 using the processing component 932. The processing component 932 (and/or the PHY 924 and/or MAC 926) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 910 may further include other platform components 934. Other platform components 934 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

The device 900 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of the device 900 described herein, may be included or omitted in various embodiments of the device 900, as suitably desired. In some embodiments, the device 900 may be configured to be compatible with protocols and frequencies associated one or more of the 3GPP LTE Specifications and/or IEEE 1402.16 Standards for WMANs, and/or other broadband wireless networks, cited herein, although the embodiments are not limited in this respect.

Embodiments of device 900 may be implemented using single input single output (SISO) architectures. However, certain implementations may include multiple antennas (e.g., antennas 918) for transmission and/or reception using adaptive antenna techniques for beamforming or spatial division multiple access (SDMA) and/or using MIMO communication techniques.

The components and features of the device 900 may be implemented using any combination of discrete circuitry, application specific integrated circuits (ASICs), logic gates and/or single chip architectures. Further, the features of the device 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary device 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium 936 may include instructions that, when executed, cause a system to perform any of the computer-implemented methods described herein.

### General Notes on Terminology

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A method, comprising:
surfacing media in an interface associated with a first user of a messaging service;
receiving an indication of interest in the media;
identifying one or more topics related to the media;
identifying at least a second user to receive updates to the media based on a predicted interest in the one or more topics by the second user; and
presenting updates on the one or more topics in a messaging thread including the first user and the second user.

2. The method of claim 1, wherein surfacing the media comprises one or more of:
presenting the media in an article view relating to a conversation between users of the messaging service that have reacted to the media; presenting the media in a chat room related to the one or more topics; or presenting the media in a media view depicting a plurality of media items based on a predicted interest in the plurality of media items by the first user.

3. The method of claim 1, wherein the media relates to a live event, and the updates are provided on a continual basis over a specified period of time.

4. The method of claim 3, further comprising presenting one or more related topics upon expiration of the specified period of time.

5. The method of claim 1, wherein the updates represent a digest of material provided by a plurality of content providers and are provided to the interface at a predefined rate.

6. The method of claim 1, wherein identifying at least the second user comprises:
identifying a plurality of potential recipient users;
ranking the plurality of potential recipients users based on an affinity of each of the potential recipient users for a publisher of the media; and
displaying the plurality of potential recipient users in an order based at least in part on the ranking.

7. The method of claim 1, wherein the media is provided by a publisher and the updates are presented for a predetermined period of time, the predetermined period of time defined by the publisher.

8. A non-transitory computer-readable medium storing:
instructions configured to cause one or more processors to access a messaging thread associated with a messaging service, the messaging thread including at least a first user and a second user;
instructions configured to cause one or more processors to analyze the messaging thread to identify one or more topics predicted to be of interest to the first user and the second user;
instructions configured to cause one or more processors to recommend the one or more topics in the messaging thread;
instructions configured to cause one or more processors to receive an indication of interest in the one or more topics; and
instructions configured to cause one or more processors to present updates on the one or more topics in the messaging thread.

9. The medium of claim 8, wherein the instructions for analyzing the messaging thread comprise instructions for retrieving one or more trending topics and comparing the one or more trending topics to the messaging thread.

10. The medium of claim 8, wherein the one or more topics relate to a live event, and the updates are provided on a continual basis over a specified period of time.

11. The medium of claim 10, further storing instructions configured to cause one or more processors to present one or more related topics upon expiration of the specified period of time.

12. The medium of claim 10, further storing instructions configured to cause one or more processors to automatically convert the live event to a topic and present updates on the topic at a predefined rate after the specified period of time expires.

13. The medium of claim 8, wherein the updates represent a digest of material provided by a plurality of content providers and are provided to the interface at a predefined rate.

14. The medium of claim 8, wherein the updates are provided by a publisher for a predetermined period of time, the predetermined period of time defined by the publisher.

15. An apparatus comprising:
a hardware processing circuit;
media surfacing logic operable on the processing circuit and configured to surface media in an interface associated with a first user of a messaging service;
input logic operable on the processing circuit and configured to receive an indication of interest in the media;
media analysis logic operable on the processing circuit and configured to identify one or more topics related to the media;
user identification logic operable on the processing circuit and configured to identify at least a second user to receive updates to the media based on a predicted interest in the one or more topics by the second user; and
a network interface configured to receive updates on the one or more topics in a messaging thread including the first user and the second user.

16. The apparatus of claim 15, wherein surfacing the media comprises one or more of:
presenting the media in an article view relating to a conversation between users of the messaging service that have reacted to the media; presenting the media in a chat room related to the one or more topics; or presenting the media in a media view depicting a plurality of media items based on a predicted interest in the plurality of media items by the first user.

17. The apparatus of claim 15, wherein the media relates to a live event, and the updates are provided on a continual basis over a specified period of time.

18. The apparatus of claim 17, further comprising additional topic logic operable on the processing circuit and configured to present one or more related topics upon expiration of the specified period of time.

19. The apparatus of claim 15, wherein the updates represent a digest of material provided by a plurality of content providers and are provided to the interface at a predefined rate.

20. The apparatus of claim 15, wherein identifying at least the second user comprises:
identifying a plurality of potential recipient users;
ranking the plurality of potential recipients users based on an affinity of each of the potential recipient users for a publisher of the media; and
displaying the plurality of potential recipient users in an order based at least in part on the ranking.
